(19) United States
(12) Patent Application Publication
(10) Pub. No.: US 2012/0121975 A1
(43) Pub. Date: May 17, 2012

(54) SURFACE MODIFIED GLASS FIBERS

(75) Inventors: Mohan Rajaram, Albany, OR (US); George C. Zguris, Canterbury, NH (US)

(73) Assignee: HOLLINGSWORTH & VOSE COMPANY, E. Walpole, MA (US)

(21) Appl. No.: 13/303,999

(22) Filed: Nov. 23, 2011

Related U.S. Application Data
(63) Continuation-in-part of application No. 12/851,107, filed on Aug. 5, 2010.
(60) Provisional application No. 61/347,165, filed on May 21, 2010.

(51) Int. Cl. H01M 2/16; C03C 13/00; D02G 3/18; H01M 10/06

(52) U.S. Cl. 429/203; 429/247; 501/35; 428/401

(57) ABSTRACT

Compositions including glass fibers with a high surface atomic percentage of oxygen bonded to silicon wherein the fibers form at least part of a battery separator or other battery component.

### PRIORITY CLAIM

The present application is a continuation-in-part of U.S. patent application Ser. No. 12/851,107 filed on Aug. 5, 2010 which claims priority to U.S. Provisional Patent Application No. 61/347,165 filed on May 21, 2010. The entire contents of each of these applications is incorporated herein by reference.

### BACKGROUND OF THE INVENTION

Batteries involve many complex electro-chemical reactions. For example, when lead acid batteries (e.g., valve regulated lead acid (“VRLA”) batteries) are overcharged, oxygen and hydrogen are generated at the positive and negative electrodes, respectively. Loss of oxygen and hydrogen from these batteries leads to a reduction in battery performance. The ability to recombine the oxygen and hydrogen within the battery to form water is therefore an aspect of lead acid battery design and manufacture that influences the overall quality and operation of these batteries. Oxygen transport is the limiting step in this recombination process because oxygen is poorly soluble in the electrolyte and diffuses slowly to and from the liquid phase. Improvements in oxygen transport are therefore desirable in order to improve various performance aspects of lead acid batteries.

### SUMMARY OF THE INVENTION

In various aspects, the present invention provides glass fibers with a surface atomic percentage of oxygen bonded to silicon of at least about 45 percent. In some embodiments, the fibers form at least a part of a battery separator. In some embodiments, the surface atomic percentage of oxygen bonded to silicon is measured by XPS at about 532.6 eV.

In some embodiments, the glass fibers include between about 50 weight percent to about 75 weight percent silica, between about 1 weight percent to about 5 weight percent aluminum oxide, and less than about 25 weight percent sodium oxide. In some embodiments, the surface atomic percentage of oxygen bonded to silicon is measured to a depth of between about 100 and 150 Angstroms from the surface of the glass fibers.

In some embodiments, the surface atomic percentage of oxygen bonded to silicon is at least about 48 percent. In some embodiments, the surface atomic percentage of oxygen bonded to silicon is at least about 51 percent. In some embodiments, the surface atomic percentage of oxygen bonded to silicon is at least about 54 percent. In some embodiments, the surface atomic percentage of oxygen bonded to silicon is at least about 57 percent. In some embodiments, the surface atomic percentage of oxygen bonded to silicon is at least about 60 percent. In some embodiments, the surface atomic percentage of oxygen bonded to silicon is at least about 63 percent. In some embodiments, the surface atomic percentage of oxygen bonded to silicon is at least about 65 percent.

In some embodiments, the surface atomic percentage of oxygen bonded to silicon is in the range of about 45 to about 65 percent. In some embodiments, the surface atomic percentage of oxygen bonded to silicon is in the range of about 51 to about 65 percent. In some embodiments, the surface atomic percentage of oxygen bonded to silicon is in the range of about 54 to about 65 percent. In some embodiments, the surface atomic percentage of oxygen bonded to silicon is in the range of about 60 to about 65 percent.

In some embodiments, the glass fibers include between about 60 weight percent and about 70 weight percent silica. In some embodiments, the glass fibers include between about 0.5 weight percent and about 30 weight percent bismuth oxide.

In some embodiments, the glass fibers have an average diameter between about 0.1 and about 10 microns. In some embodiments, the glass fibers have an average diameter between about 0.5 and about 2 microns. In some embodiments, the glass fibers have an average diameter between about 0.5 and about 1 microns. In some embodiments, the glass fibers have an average diameter between about 1 and about 2 microns.

In various aspects, the present invention provides a battery that includes a first and a second electrode, wherein at least one of the first and second electrodes includes lead; a separator between the first and second electrodes, wherein the separator includes glass fibers with a surface atomic percentage of oxygen bonded to silicon of at least about 45 percent; and an electrolytic solution.

In various aspects, the present invention provides a lead acid battery that includes positive and negative electrodes; an electrolytic solution; and a means for shifting the voltage at which hydrogen is produced at the negative electrode by between about 10 mV and about 120 mV. In some embodiments, the lead acid battery includes a means for shifting the voltage at which hydrogen is produced at the negative electrode by between about 30 mV and about 60 mV.

### BRIEF DESCRIPTION OF THE DRAWINGS

FIG. 1 shows the typical reactions and transport of the oxygen cycle within a battery.

FIG. 2 shows the current profile during a recharging cycle.

FIG. 3 shows a comparison of the voltage profile of a battery during recharging with the gas flow vented from the battery during the same time.

FIG. 4 shows the difference in electrode potentials between a flooded battery and a VRLA battery with oxygen recombination cycle.

FIG. 5 shows the voltage profile of a VRLA battery with recombination (thin line), and flooded battery (heavy line).

FIG. 6 shows the current profile of a test cell with and without standard glass fibers.

FIG. 7 shows the current profile of a test cell with and without surface modified glass fibers.

FIG. 8 shows an O1s peak fit profile from x-ray photoelectron spectroscopy (“XPS”) analysis of surface modified glass fibers (produced in an oxygen rich atmosphere).

FIG. 9 shows a typical XPS survey scan of surface modified glass fibers (produced in an oxygen rich atmosphere).

FIG. 10 shows an O1s Peak fit profile from XPS analysis of unmodified (control) glass fibers (408 control).

FIGS. 11A and B show O1s peak fit profiles from XPS analysis of surfaced modified glass fibers (AAA-52D) (duplicate tests).

FIGS. 12A-F show various peak fit profiles from XPS analysis of unmodified (control) glass fibers (408 control).

FIGS. 13A-F show various peak fit profiles from XPS analysis of surface modified glass fibers (AAA-52D).

FIG. 14 shows an XPS survey scan for unmodified (control) glass fibers (408 control).

FIG. 15 shows an XPS survey scan for surface modified glass fibers (AAA-52D).

FIG. 16 shows electron micrographs of two sets of glass fibers, unmodified glass fibers on the left, and surface modified glass fibers on the right.

FIG. 17 shows a higher magnification of electron micrographs of two sets of glass fibers, unmodified glass fibers on the left, and surface modified glass fibers on the right.

### DETAILED DESCRIPTION OF VARIOUS EMBODIMENTS OF THE INVENTION

### Overcharging and Oxygen Recombination in Lead Acid Batteries

Overcharge conditions in a battery can affect battery life and performance. Overcharge is the amount of extra charge needed to overcome inefficiencies in recharging the battery. The more efficient the battery is, the less overcharge is required. The discharge reactions of a battery (e.g., a lead-acid battery) are well known:

Pb(s)+HSO₄⁻(aq)→PbSO₄(s)+H⁺+2e⁻

PbO₂(s)+3H⁺(aq)+HSO₄⁻(aq)+2e⁻→PbSO₄(s)+2H₂O

Net: Pb(s)+PbO₂(s)+2H⁺(aq)+2HSO₄⁻(aq)→2PbSO₄(s)+2H₂O

The reverse reactions for recharging the battery:

PbSO₄(s)+H⁺+2e⁻→Pb(s)+HSO₄(aq)

PbSO₄(s)+2H₂O→PbO₂(s)+3H⁺(aq)+HSO₄⁻(aq)+2e⁻

Net: 2PbSO₄(s)+2H₂O→Pb(s)+PbO₂(s)+2H⁺(aq)+2HSO₄⁻(aq)

Once the battery has reached full charge, an overcharging condition is present and the contents of the battery (e.g., water in the electrolyte) undergo the following reactions at the positive and negative electrode, respectively:

2H₂O→oxygen+4H⁺+4e⁻ (oxygen generation from the positive electrode)

4H′+4e⁻→H₂ (H₂ generation from the negative electrode)

oxygen+4H⁺+4e⁻→2H₂O (oxygen recombination at the negative electrode)

A sulfate intermediate is formed at the negative electrode during recombination. Reactions around this intermediate can be expressed as follows:

2Pb+oxygen+2H₂SO₄→2PbSO₄+2H₂O

2PbSO₄+4H⁺4e⁻→2Pb+2H₂SO₄

In a VRLA battery the internal environment is controlled by a valve that vents gas (e.g., hydrogen, oxygen) from the battery as pressure builds. The valve is a pressure relief valve, only opening when the internal battery pressure reaches a threshold. When the internal pressure in the battery is below this threshold the valve prevents either gas from escaping. The generated oxygen can diffuse from the positive electrode to the negative electrode, and recombine with the hydrogen to form water.

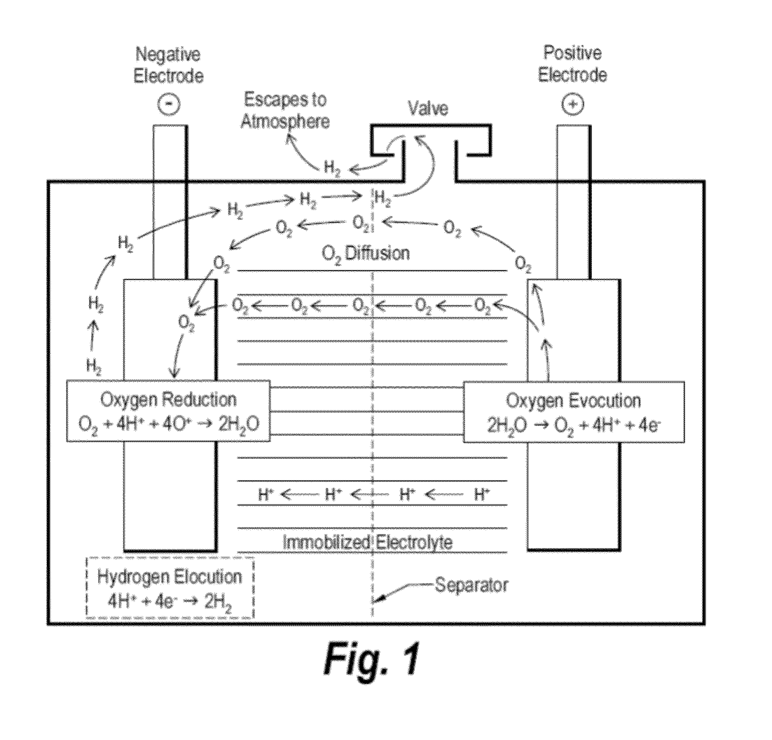

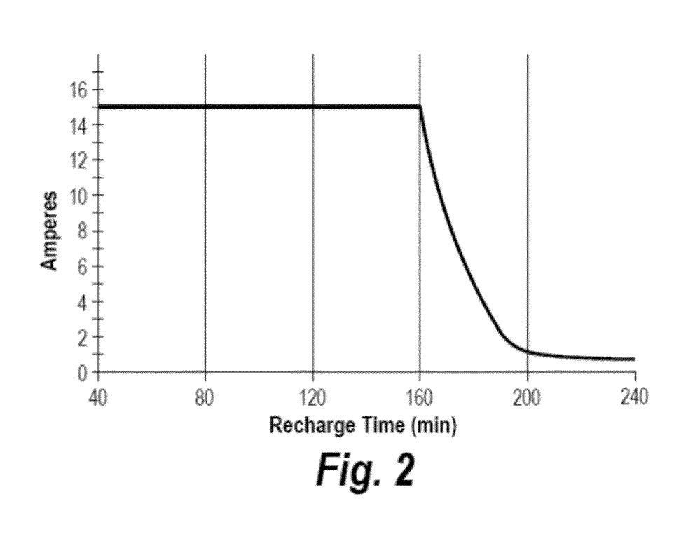

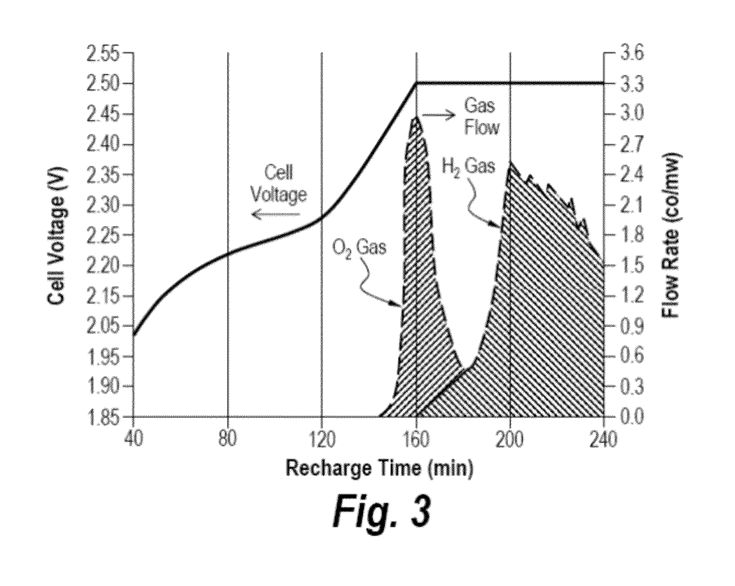

FIG. 1 illustrates the typical reactions and transport of the oxygen cycle within a VRLA battery. FIG. 2 illustrates the current profile during a recharging cycle. Notably the current is constant until a point just prior to 160 minutes when the current drops. The drop signifies the end of the “bulk charging” period and commencement of the “overcharging” condition. As described above and as shown in FIG. 1, the overcharging period is a dynamic situation. FIG. 3 compares the voltage profile of a battery during recharging with the gas flow developed and vented from the battery during the same time period. Gas generation during the overcharging condition is clearly visible in FIG. 3. Indeed, after nearly 160 minutes of charging the voltage stabilizes at about 2.50 volts and gas starts to vent from the cell. Gas analysis shows that the first spike in gas flow is mostly oxygen. The subsequent decrease in vented oxygen is likely due to the oxygen recombination reaction at the negative electrode. The second spike in vented gas flow is from hydrogen generation at the negative electrode.

The ability of oxygen and hydrogen to recombine in the battery governs several facets of the battery performance and safety. Pure oxygen and hydrogen are explosive gases, and thus recombination is important to avoid an explosive battery. A low level of oxygen and hydrogen recombination also negatively affects the charge acceptance of the battery. Indeed, gassing at the negative electrode is indicative of an exponentially rising negative electrode voltage which adds to the positive electrode voltage to reach the voltage limit electrically allowed. To keep the battery voltage under the voltage limit, current flow is reduced and less charge can be accepted by the battery, thus reducing charge acceptance. A low level of recombination may also reduce cycle life (cycle life being the number of charge-discharge cycles before a specific level of capacity is irreversibly lost). As described above, less recombined oxygen gas allows the negative electrode potential to reach a hydrogen gassing state. Hydrogen evolution and hydrogen escape occurs since hydrogen is not recombined under normal conditions and leaves the system resulting in water loss. Water loss reduces a VRLA battery's useful capacity which in turn limits the amount of cycles the battery can accumulate over its lifetime.

The desirable effects of improved oxygen recombination must be balanced by its negative effects on the battery as well. The recombination reaction is an exothermic reaction, and drives up the temperature in the battery, which in turn further increases the rate of oxygen recombination. Adding to the rate of oxygen recombination is the content of water in the battery, which is also affected by the rate of gas generation (e.g., by overcharging). As the water content in the battery decreases, the rate of oxygen recombination increases, further increasing the heat generated. Water loss also increases electrical resistance in the cell, further increasing the heat. An optimal electrolyte saturation level occurs when gas can transfer freely, but not excessively which occurs if an excessive amount of water is lost from the system.

The rate of oxygen recombination is largely determined by the rate of oxygen transport within the cell. For example, in conventional liquid electrolyte batteries, oxygen is poorly soluble in the electrolyte and the diffusion rate for oxygen through and from the electrolyte is very slow. As a result, the recombination rate is very slow, so much so that recombination is considered by one of ordinary skill in the art to not occur at all. In VRLA batteries, particularly those with glass mat separators, the reaction is typically faster, as the glass saturation level decreases (i.e., the amount of glass fibers in the separator and battery as a whole) help oxygen transport through the separator. Non-saturated areas, provided by the battery separator, help oxygen transport within the cell, and thus improve oxygen recombination in a VRLA battery as compared to a flooded battery. The silica surfaces of the glass fiber separator are shown to improve transport as well in various embodiments of the provided inventions.

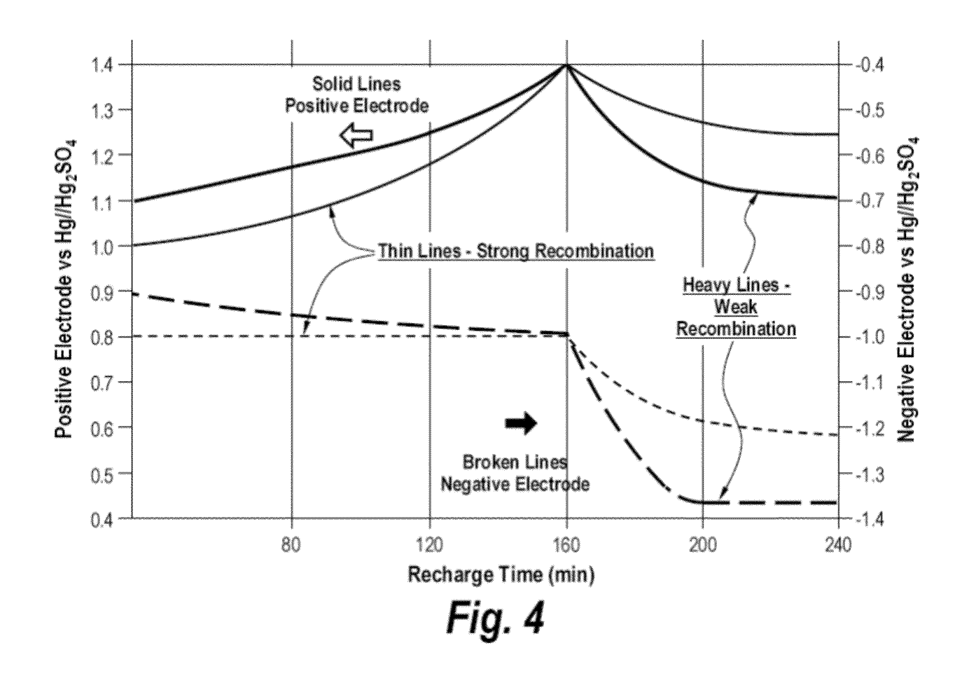

As noted above, oxygen recombination affects the cycling of a battery. Batteries with poor oxygen recombination show lower positive electrode polarization and electrical potential. High positive electrode potentials accompany superior cycling performance. FIG. 4 compares the electrode potentials of a battery with strong recombination (e.g., VRLA, thin line) and a battery with weak recombination (e.g., standard flooded, thick line). The solid lines (upper plots) and the dashed lines (lower plots) denote the electrode potential for the positive and negative electrodes, respectively. Both the positive and negative electrode potentials of the battery with strong recombination are higher, yielding a battery with superior cycling ability, as compared to the battery with weak recombination.

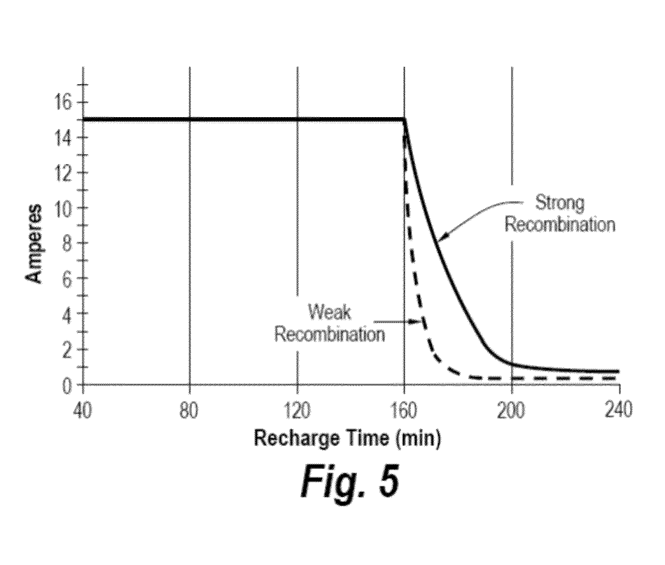

A battery with superior oxygen recombination will also have higher charge acceptance. FIG. 5 shows the current profile of a VRLA battery with strong recombination (solid line) and a flooded battery (no, or poor, recombination, dashed line). Again, the VRLA battery with strong recombination shows a higher charge acceptance at the negative electrode as indicated by the higher current after about 160 minutes (i.e., after a full charge is completed).

The characteristics of a battery separator can influence the rate of recombination of oxygen, and thus the efficiency and performance of the battery. Indeed, battery separators with superior oxygen transport capability can lead to greater transference of oxygen within the battery and therefore a safer battery with improved performance for the reasons described above (i.e., improved cycling, greater electrode potential, higher charge acceptance, etc.). In addition, more electrolyte can be added as compared to a battery with a separator that has inferior oxygen transport capability.

### Surface Modified Glass Fibers

As demonstrated herein, we have discovered that one method of improving oxygen transference or oxygen transfer within a lead acid battery is to provide a separator made of glass fibers with surfaces that include an enhanced percentage of oxygen atoms that are bonded to silicon (a surface modified glass fiber).

In some embodiments, the percentage of oxygen atoms that are bonded to silicon in the glass fiber surface can be increased by modifying the conditions during glass fiber formation. Thus, as described below, we have shown that this can be achieved by using an oxygen enriched combustion stream during fiberization.

In some embodiments, the percentage of oxygen atoms that are bonded to silicon in the glass fiber surface can be increased by depositing silica (e.g., amorphous silica) on the surface of glass fibers. As described below, chemical vapor deposition (“CVD”) methods can be used for this purpose. Because the CVD deposited layer is pure silica, without other typical glass fiber components (e.g., sodium, calcium, etc.), the percentage of oxygen, and in particular, oxygen bonded to silicon, is higher as compared to the surface of an unmodified glass fiber.

The amount and bond configuration of oxygen atoms in glass fiber surfaces is most readily measured by X-ray photoelectron spectroscopy (“XPS”). XPS is a quantitative, analytical method that measures the atomic composition of the surface of a material. Generally, this is accomplished by irradiating the material with X-ray radiation, and measuring the kinetic energy and quantity of photoelectrons that are ejected from the material by the X-rays. XPS only detects electrons that emanate from the surface of the material because the electrons that are generated by XPS can only travel a short distance within the material. Typically the surface depth analyzed in XPS is between about 100 and about 150 Angstroms, and in some embodiments up to about 200 Angstroms.

The kinetic energy of the electrons emanating from the surface will vary depending on the kind of atom they came from (oxygen, silicon, carbon, etc.) but also the type of bond the atom was in (oxygen-silicon, oxygen-carbon, etc.). Thus, XPS not only provides information about the amount of particular atoms on the surface of a material, but also the bond configuration of those atoms. For example, electrons from oxygen atoms that are bonded to silicon (e.g., oxygen in silica or SiO₂) produce a characteristic peak at about 532.6 eV in XPS spectra (also called sp3 bond peak). The corresponding silicon atoms produce a characteristic peak at about 103.5 eV (also called Si2p peak). The quantity of electrons with a particular energy is proportional to the number atoms with the same chemical configuration (i.e., same type of atom and same type of bond). Thus, by integrating the area under different peaks obtained by XPS one can determine the relative percentage of different atoms in the surface of the material. Significantly, XPS does not detect every type of atom present in the surface (e.g., hydrogen atoms do not produce a measurable peak in XPS spectra). As a result, the “atomic percentage” of a given atom that is determined by XPS may in fact be higher than the actual percentage of the atom in the surface of the material (i.e., when all atoms are taken into account including those that are not detected by XPS). It is therefore to be understood that all “atomic percentage” values that are discussed herein are intended to refer to the atomic percentage values as determined by XPS and may not in fact reflect the actual atomic percentage values in the material.

Surface Atomic Percentage of Oxygen (Bonded to Silicon)

Exemplary glass fibers (e.g., 609M glass fibers) that are made in a traditional manner have a particular surface atomic percentage of oxygen atoms that are bonded to silicon (as measured by XPS). Comparable surface modified glass fibers that are described herein, display higher percentages than their traditional (i.e., unmodified) counterparts, despite having the same glass chemistry and fiber geometry. In some embodiments, the surface atomic percentage of oxygen atoms bonded to silicon is at least about 34 percent (as measured at about 532.6 eV in XPS spectra). Without limitation, this percentage is sometimes referred to herein as the “sp3 bond concentration.” In some embodiments, the surface atomic percentage of oxygen bonded to silicon is at least about 35 percent. In some embodiments, the surface atomic percentage of oxygen bonded to silicon is at least about 36 percent. In some embodiments, the surface atomic percentage of oxygen bonded to silicon is at least about 37 percent. In some embodiments, the surface atomic percentage of oxygen bonded to silicon is at least about 38 percent. In some embodiments, the surface atomic percentage of oxygen bonded to silicon is at least about 39 percent. In some embodiments, the surface atomic percentage of oxygen bonded to silicon is at least about 40 percent. In some embodiments, the surface atomic percentage of oxygen bonded to silicon is at least about 41 percent. In some embodiments, the surface atomic percentage of oxygen bonded to silicon is at least about 42 percent. In some embodiments, the surface atomic percentage of oxygen bonded to silicon is at least about 45 percent. In some embodiments, the surface atomic percentage of oxygen bonded to silicon is at least about 47 percent. In some embodiments, the surface atomic percentage of oxygen bonded to silicon is at least about 50 percent. In some embodiments, the surface atomic percentage of oxygen bonded to silicon is at least about 52 percent. In some embodiments, the surface atomic percentage of oxygen bonded to silicon is at least about 55 percent. In some embodiments, the surface atomic percentage of oxygen bonded to silicon is at least about 57 percent. In some embodiments, the surface atomic percentage of oxygen bonded to silicon is at least about 60 percent. In some embodiments, the surface atomic percentage of oxygen bonded to silicon is at least about 62 percent. In some embodiments, the surface atomic percentage of oxygen bonded to silicon is at least about 65 percent.

In some embodiments, the surface atomic percentage of oxygen bonded to silicon is at most about 65 percent. In some embodiments, the surface atomic percentage of oxygen bonded to silicon is at most about 60 percent. In some embodiments, the surface atomic percentage of oxygen bonded to silicon is at most about 55 percent. In some embodiments, the surface atomic percentage of oxygen bonded to silicon is at most about 50 percent. In some embodiments, the surface atomic percentage of oxygen bonded to silicon is at most about 45 percent.

In some embodiments, the surface atomic percentage of oxygen bonded to silicon ranges between any of the values described above, e.g., between about 35 and about 65 percent, between about 35 and about 60 percent, between about 35 and about 55 percent, between about 35 and about 50 percent, between about 40 and about 65 percent, between about 40 and about 60 percent, between about 40 and about 55 percent, between about 40 and about 50 percent, between about 45 and about 65 percent, between about 45 and about 60 percent, between about 45 and about 55 percent, between about 45 and about 50 percent, between about 50 and about 65 percent, between about 50 and about 60 percent, between about 50 and about 55 percent, between about 55 and about 65 percent, between about 55 and about 65 percent, or between about 60 and about 65 percent.

In some embodiments, the aforementioned percentages are obtained with glass fibers having an average diameter within a particular size range. Thus, in some embodiments, these percentages are obtained with glass fibers that have an average diameter in the range of about 0.5 to about 2 microns, e.g., about 0.5 to about 1 microns, about 0.7 to about 0.9 microns, about 1 to about 2 microns, or about 1.2 to about 1.7 microns.

In some embodiments, the percentage is at least about 34 percent (e.g., about 34 to about 45 percent, about 34 to about 40 percent, about 34 to about 38 percent, about 35 to about 45 percent, about 35 to about 40 percent, about 35 to about 38 percent) and is obtained with glass fibers that have an average diameter in the range of about 1 to about 2 microns. In some embodiments, these percentages are obtained with glass fibers that have an average diameter in the range of about 1 to about 1.7 microns. In some embodiments, these percentages are obtained with glass fibers that have an average diameter in the range of about 1.2 to about 1.7 microns. In certain embodiments, these percentages are obtained with glass fibers that have an average diameter of about 1.4 microns.

In some embodiments, the percentage is at least about 45 percent (e.g., at least about 50 percent, at least about 55 percent, about 45 to about 65 percent, about 50 to about 60 percent) and is obtained with glass fibers that have an average diameter in the range of about 0.5 to about 1 microns. In some embodiments, these percentages are obtained with glass fibers that have an average diameter in the range of about 0.6 to about 0.9 microns. In some embodiments, these percentages are obtained with glass fibers that have an average diameter in the range of about 0.7 to about 0.9 microns. In certain embodiments, these percentages are obtained with glass fibers that have an average diameter of about 0.8 microns.

### Normalized Percentages

In some embodiments, it may be advantageous to convert any one of the aforementioned surface atomic percentages (or any of the subsequent surface atomic percentages) to a “normalized” value that takes into account the average diameter and/or the specific surface area of the underlying glass fiber. For example, as discussed in the Examples, one might “normalize” the percentage values obtained by XPS based on the relative specific surface areas of the underlying glass fibers to obtain new “normalized” values that can then be compared. In some embodiments, this may facilitate comparisons of percentage values that were obtained using glass fibers that have different geometries. It is therefore to be understood that the present invention also provides glass fibers that are defined based on a “normalized” percentage, e.g., with respect to the specific surface area of a reference glass fiber such as the Evanite 609M glass fibers that were used as reference fibers in the Examples.

Thus, in some embodiments, the present invention provides glass fibers with a surface atomic percentage of oxygen atoms bonded to silicon that is at least about 35 percent (as measured at about 532.6 eV in XPS spectra and “normalized” to a glass fiber with a specific surface area of 1.76 m²/g such as Evanite 609M). In some embodiments, this “normalized” surface atomic percentage of oxygen atoms bonded to silicon may be at least about 36 percent, at least about 37 percent, at least about 38 percent, at least about 39 percent, at least about 40 percent, or at least about 45 percent. In some embodiments, this “normalized” surface atomic percentage of oxygen atoms bonded to silicon may be at most about 45 percent, e.g., at most about 40 percent, at most about 39 percent, at most about 38 percent, at most about 37 percent, or at most about 36 percent. In some embodiments, this “normalized” surface atomic percentage of oxygen atoms bonded to silicon may be in the range of about 35 to about 45 percent, e.g., about 35 percent to about 43 percent, about 35 percent to about 41 percent, about 35 percent to about 39 percent, about 35 percent to about 37 percent, about 37 percent to about 45 percent, about 37 percent to about 43 percent, about 37 percent to about 41 percent, about 37 percent to about 39 percent, about 39 percent to about 45 percent, about 39 percent to about 43 percent, or about 39 percent to about 41 percent.

Surface Atomic Percentage of Silicon (Bonded to Oxygen)

The previous sections defined the glass fibers based on the surface atomic percentage of oxygen atoms that are bonded to silicon. In some embodiments, it may be advantageous to define the glass fibers (additionally or alternatively) based on the surface atomic percentage of silicon atoms that are bonded to oxygen. As discussed in the Examples, these silicon atoms produce a characteristic peak at about 103.5 eV in XPS spectra. In some embodiments, the surface atomic percentage of silicon atoms that are bonded to oxygen is at least about 22 percent (as measured at about 103.5 eV in XPS spectra). Without limitation, this percentage is sometimes referred to herein as the “Si2p bond concentration.” In some embodiments, the surface atomic percentage of silicon bonded to oxygen is at least about 24 percent. In some embodiments, the surface atomic percentage of silicon bonded to oxygen is at least about 26 percent. In some embodiments, the surface atomic percentage of silicon bonded to oxygen is at least about 28 percent. In some embodiments, the surface atomic percentage of silicon bonded to oxygen is at least about 30 percent. In some embodiments, the surface atomic percentage of silicon bonded to oxygen is at least about 32 percent.

In some embodiments, the surface atomic percentage of oxygen bonded to silicon is at most about 34 percent. In some embodiments, the surface atomic percentage of oxygen bonded to silicon is at most about 32 percent. In some embodiments, the surface atomic percentage of oxygen bonded to silicon is at most about 30 percent. In some embodiments, the surface atomic percentage of oxygen bonded to silicon is at most about 28 percent. In some embodiments, the surface atomic percentage of oxygen bonded to silicon is at most about 26 percent. In some embodiments, the surface atomic percentage of oxygen bonded to silicon is at most about 24 percent.

In some embodiments, the surface atomic percentage of silicon bonded to oxygen ranges between any of the values described above, e.g., between about 22 and about 34 percent, between about 22 and about 32 percent, between about 22 and about 30 percent, between about 22 and about 28 percent, between about 22 and about 26 percent, between about 24 and about 34 percent, between about 24 and about 32 percent, between about 24 and about 30 percent, between about 24 and about 28 percent, between about 24 and about 26 percent, between about 26 and about 34 percent, between about 26 and about 32 percent, between about 26 and about 30 percent, between about 26 and about 28 percent between about 28 and about 34 percent, between about 28 and about 32 percent, between about 28 and about 30 percent, between about 30 and about 34 percent, between about 30 and about 32 percent, or between about 32 and about 34 percent.

Ratio of Oxygen to Silicon in Oxygen-Silicon Bonds

In some embodiments it may be advantageous to refer to the ratio of oxygen (bonded to silicon) to silicon (bonded to oxygen) as measured in the glass fiber surface by XPS (at about 532.6 eV and about 103.5 eV, respectively). If the surface is a pure silica coating (SiO₂) then the ratio of these two percentages should approach about 2 (i.e., about 66 percent oxygen atoms and about 33 percent silicon atoms). In some embodiments, this ratio is in the range of about 1 to about 2. In some embodiments, the ratio is in the range of about 1.1 to about 1.9, e.g., about 1.2 to about 1.8, about 1.3 to about 1.8, about 1.4 to about 1.8, about 1.5 to about 1.8, about 1.6 to about 1.8, about 1.2 to about 1.7, about 1.3 to about 1.7, about 1.4 to about 1.5, or about 1.6 to about 1.7.

Surface Atomic Percentage of Oxygen at about 532.6 eV in XPS Spectra

As discussed in the Examples, oxygen that is bonded to carbon (instead of silicon) can also produce a peak at about 532.6 eV in XPS spectra. When this type of oxygen is also present in the surface its contribution to the 532.6 eV peak can be accounted for by analyzing the peaks that are produced by the corresponding carbons atoms (e.g., see Example 4). In some embodiments however it may be advantageous to ignore this overlap and refer to the surface atomic percentage of oxygen at about 532.6 eV (i.e., irrespective of whether the oxygen is bonded to silicon or carbon) (e.g., see Example 3).

In some embodiments, the surface atomic percentage of oxygen at about 532.6 eV is at least about 37 percent. In some embodiments, the surface atomic percentage of oxygen at about 532.6 eV is at least about 39 percent. In some embodiments, the surface atomic percentage of oxygen at about 532.6 eV is at least about 42 percent. In some embodiments, the surface atomic percentage of oxygen at about 532.6 eV is at least about 45 percent. In some embodiments, the surface atomic percentage of oxygen at about 532.6 eV is at least about 48 percent. In some embodiments, the surface atomic percentage of oxygen at about 532.6 eV is at least about 51 percent. In some embodiments, the surface atomic percentage of oxygen at about 532.6 eV is at least about 54 percent. In some embodiments, the surface atomic percentage of oxygen at about 532.6 eV is at least about 55 percent. In some embodiments, the surface atomic percentage of oxygen at about 532.6 eV is at least about 56 percent. In some embodiments, the surface atomic percentage of oxygen at about 532.6 eV is at least about 57 percent.

In some embodiments, the surface atomic percentage of oxygen at about 532.6 eV is at most about 60 percent. In some embodiments, the surface atomic percentage of oxygen at about 532.6 eV is at most about 57 percent. In some embodiments, the surface atomic percentage of oxygen at about 532.6 eV is at most about 54 percent. In some embodiments, the surface atomic percentage of oxygen at about 532.6 eV is at most about 51 percent. In some embodiments, the surface atomic percentage of oxygen at about 532.6 eV is at most about 48 percent. In some embodiments, the surface atomic percentage of oxygen at about 532.6 eV is at most about 45 percent. In some embodiments, the surface atomic percentage of oxygen at about 532.6 eV is at most about 42 percent. In some embodiments, the surface atomic percentage of oxygen at about 532.6 eV is at most about 39 percent.

In some embodiments, the surface atomic percentage of oxygen at about 532.6 eV ranges between any of the values described above, e.g., between about 37 and about 60 percent, between about 37 and about 54 percent, between about 37 and about 51 percent, between about 37 and about 48 percent, between about 37 and about 45 percent, between about 37 and about 42 percent, between about 37 and about 39 percent, between about 39 and about 57 percent, between about 39 and about 54 percent, between about 39 and about 51 percent, between about 39 and about 48 percent, between about 39 and about 45 percent, between about 39 and about 42 percent, between about 41 and about 57 percent, between about 41 and about 54 percent, between about 41 and about 51 percent, between about 41 and about 48 percent, between about 41 and about 45 percent, between about 41 and about 42 percent, between about 45 and about 57 percent, between about 45 and about 54 percent, between about 45 and about 51 percent, between about 45 and about 48 percent, between about 47 and about 57 percent, between about 47 and about 54 percent, between about 47 and about 51 percent, between about 47 and about 48 percent, between about 49 and about 57 percent, between about 49 and about 54 percent, between about 49 and about 51 percent, between about 51 and about 57 percent, between about 51 and about 54 percent, or between about 54 and about 57 percent.

### Hydrogen Shift

In some embodiments, the surface modified glass fibers may be defined (additionally or alternatively) based on the hydrogen shift that they induce as compared to their unmodified counterparts. For example, in some embodiments, the surface modified glass fibers may be defined based on the hydrogen shift that is observed when a defined amount of the fibers (e.g., 0.25 g which could be in the form of loose fibers or in the form of fibers within a separator) are added to 400 ml of a 1.26 g/cm³ sulfuric acid solution and then tested in accordance with the methods of Example 1 (i.e., a variation of the BCIS-03a Rev. February 02 test where the oxygen generating counter electrode is in the same vessel as the working negative electrode). In certain embodiments, the tests are performed with a current of 0.02 A. In certain embodiments, the tests are performed with a current of 0.03 A. The desired electrochemical effect can be a shift in the voltage at which hydrogen is produced, as compared to an otherwise identical control that uses the same amount of unmodified glass fiber (e.g., Evanite 608M instead of the oxygenated Evanite 608M which in Example 2 caused a shift in the range of about 45 mV to about 50 mV depending on the current used). In some embodiments the desired hydrogen shift can be from about 10 mV to about 120 mV. In some embodiments, the desired hydrogen shift can be from about 10 mV to about 20 mV, from about 10 mV to about 30 mV, from about 10 mV to about 60 mV, from about 10 mV to about 120 mV, from about 20 mV to about 30 mV, from about 25 mV to about 50 mV, from about 30 mV to about 40 mV, from about 30 mV to about 60 mV, from about 30 mV to about 90 mV, from about 30 mV to about 120 mV, from about 40 mV to about 50 mV, from about 40 mV to about 60 mV, from about 50 mV to about 60 mV, from about 50 mV to about 75 mV, from about 60 mV to about 120 mV, from about 75 mV to about 100 mV. In some embodiments the desired shift can be at least about 10 mV, at least about 20 mV, at least about 25 mV, at least about 30 mV, at least about 40 mV, at least about 50 mV, at least about 75 mV, at least about 100 mV, at least about 110 mV. In some embodiments, the desired shift can be at most about 120 mV, at most about 100 mV, at most about 75 mV, at most about 50 mV, at most about 40 mV, at most about 30 mV, at most about 25 mV, at most about 20 mV or at most about 10 mV.

In some embodiments, the present invention provides a lead acid battery that includes a means for shifting the voltage at which hydrogen is produced at the negative electrode by between about 10 mV and about 120 mV, e.g., from about 10 mV to about 30 mV, from about 10 mV to about 60 mV, from about 10 mV to about 120 mV, from about 20 mV to about 30 mV, from about 25 mV to about 50 mV, from about 30 mV to about 40 mV, from about 30 mV to about 60 mV, from about 30 mV to about 90 mV, from about 30 mV to about 120 mV, from about 40 mV to about 50 mV, from about 40 mV to about 60 mV, from about 50 mV to about 60 mV, from about 50 mV to about 75 mV, from about 60 mV to about 120 mV, from about 75 mV to about 100 mV.

### Oxygen Rich Fiberization Methods

Glass fibers are typically manufactured in a flame attenuated flame blower. One method for obtaining surface modified glass fibers is to make the glass fibers with a combustion flame that is lean in hydrocarbon or enriched in oxygen. This approach may be extended to other fiberization methods, e.g., rotary fiberizers, control attenuated technology, etc. Turning to the flame attenuated methods, changing the hydrocarbon fuel (e.g., natural gas) to air ratio from the traditional, stoichiometrically proportioned, ratio of 1:10 to a ratio lean in hydrocarbon fuel by adding more air or oxygen to the feed results in an increased oxidizing environment in the flame. Oxygen can be directly added to either the air or hydrocarbon fuel line. As used herein, air refers to the oxidant source in the combustion reaction, whether atmospheric air, or air with added oxygen. In some embodiments, the concentration of oxygen in the air is between about 20.9 volume percent and about 100 volume percent. In some embodiments, the concentration of oxygen in air ranges between 7.5 volume percent to about 20.9 volume percent. Without being bound to a particular theory, it is thought that the oxygen rich flame facilitates the formation of more oxygen-silicon bonds on the surface of the glass fiber, as opposed to a stoichiometrically proportioned flame.

In some embodiments, the ratio of fuel to air is at least about 1:10, at least about 1:15, at least about 1:20, at least about 1:25, at least about 1:30, at least about 1:40, at least about 1:50, at least about 1:60, at least about 1:75, at least about 1:80, at least about 1:90, or at least about 1:100.

In some embodiments, oxygen is added to either the air or combustion stream. In some embodiments, the air may be up to about 25 percent oxygen by volume. In some embodiments, the air may be up to about 23.5 percent oxygen by volume. In some embodiments, the air may be up to about 22.5 percent oxygen by volume. In some embodiments, the air may be up to about 21.5 percent oxygen by volume. In some embodiments, the air may be up to about 20.5 percent oxygen by volume. In some embodiments, the air may be up to about 17.5 percent oxygen by volume. In some embodiments, the air may be up to about 15 percent oxygen by volume. In some embodiments, the air may be up to about 12.5 percent oxygen by volume. In some embodiments, the air may be up to about 10 percent oxygen by volume. In some embodiments, the air may be up to about 7.5 percent oxygen by volume. In some embodiments, the air may be up to about 5 percent oxygen by volume.

In some embodiments, the air may be between about 23.5 percent oxygen and about 25 percent oxygen. In some embodiments, the air may be between about 21.5 percent oxygen and about 23.5 percent oxygen. In some embodiments, the air may be between about 20.5 percent oxygen and about 21.5 percent oxygen. In some embodiments, the air may be between about 21.5 percent oxygen and about 25 percent oxygen. In some embodiments, the air may be between about 20.5 percent oxygen and about 23.5 percent oxygen. In some embodiments, the air may be between about 15 percent oxygen and about 17.5 percent oxygen. In some embodiments, the air may be between about 12.5 percent oxygen and about 15 percent oxygen. In some embodiments, the air may be between about 10 percent oxygen and about 15 percent oxygen. In some embodiments, the air may be between about 7.5 percent oxygen and about 12.5 percent oxygen.

In some embodiments, the oxygen is expressed as additional volumetric percentage over standard atmospheric volumetric percentage of oxygen in air. For example, a 2.7 volume percent enrichment of oxygen gives a final volume percentage of 23.6 oxygen in the fuel, based on 20.9 volume percent of air being oxygen. In some embodiments, the volume addition of oxygen is at most about 1 percent by volume. In some embodiments, the volume addition of oxygen is at most about 1.5 percent by volume. In some embodiments, the volume addition of oxygen is at most about 2 percent by volume. In some embodiments, the volume addition of oxygen is at most about 2.5 percent by volume. In some embodiments, the volume addition of oxygen is at most about 2.7 percent by volume. In some embodiments, the volume addition of oxygen is at most about 3 percent by volume. In some embodiments, the volume addition of oxygen is at most about 3.5 percent by volume. In some embodiments, the volume addition of oxygen is at most about 4 percent by volume. In some embodiments, the volume addition of oxygen is at most about 4.5 percent by volume. In some embodiments, the volume addition of oxygen may be between about 1 percent by volume and about 2 percent by volume. In some embodiments, the volume addition of oxygen may be between about 2 percent by volume and about 3 percent by volume. In some embodiments, the volume addition of oxygen may be between about 3 percent by volume and about 4 percent by volume. In some embodiments, the volume addition of oxygen may be between about 1.5 percent by volume and about 2.5 percent by volume. In some embodiments, the volume addition of oxygen may be between about 2.5 percent by volume and about 3.5 percent by volume. In some embodiments, the volume addition of oxygen may be between about 3.5 percent by volume and about 4.5 percent by volume.

### Silica Coatings by Chemical Vapor Deposition

Another method for obtaining surface modified glass fibers is to create (e.g., deposit) a layer of silica (e.g., amorphous silica) on the glass fiber. Without limitation, this could be achieved after the glass fiber is formed, or after the glass fibers are formed into a battery separator (a process described below). As noted above, glass fibers are typically manufactured in a flame attenuated flame blower; however, other fiberization methods may be used (e.g., rotary fiberizers, control attenuated technology, etc.). Once the glass fibers are formed, chemical vapor deposition (“CVD”) methods can be used to deposit a layer of silica on the surface of the glass fibers (via methods described below). Alternatively or additionally, the glass fibers can be formed into a battery separator and then CVD methods can be used to form a layer of silica on the fibers within the separator. Without limitation, a possible advantage of using the latter method is that it avoids passing the coated glass fibers through all the processing steps that are involved in producing a separator (e.g., a wet laid process).

In some embodiments the coating is less than 1 micron in thickness. In some embodiments the coating thickness is in the range of about 10 nm to about 100 nm, e.g., about 50 nm to about 100 nm, about 50 nm to about 1000 nm, about 100 nm to about 1000 nm, about 500 nm to about 1000 nm, about 500 nm to about 2000 nm, about 1000 nm to about 2000 nm, about 1000 nm to about 3000 nm, about 1000 nm to about 4000 nm, about 2000 nm to about 4000 nm, about 3000 nm to about 5000 nm, about 5 μm to about 10 μm, about 5 μm to about 25 μm, about 10 μm to about 25 μm, about 10 μm to about 50 μm, about 50 μm to about 100 μm, about 50 μm to about 250 μm, about 100 μm to about 250 μm, about 100 μm to about 500 μm, about 250 μm to about 500 μm, about 250 μm to about 1000 μm, about 500 μm to about 1000 μm, or any ranges therebetween.

In some embodiments, the deposition rate (measured in thickness of coating deposited per hour) can range from about 0.1 μm/hr to about 1000 μm/hr. In some embodiments, the deposition rate ranges from about 0.1 μm/hr to about 10 μm/hr, from about 1 μm/hr to about 10 μm/hr, from about 5 μm/hr to about 10 μm/hr, from about 5 μm/hr to about 25 μm/hr, from about 5 μm/hr to about 100 μm/hr, from about 25 μm/hr to about 100 μm/hr, from about 50 μm/hr to about 250 μm/hr, from about 100 μm/hr to about 250 μm/hr, from about 100 μm/hr to about 500 μm/hr, from about 250 μm/hr to about 500 μm/hr, from about 250 μm/hr to about 750 μm/hr, from about 500 μm/hr to about 750 μm/hr, from about 500 μm/hr to about 1000 μm/hr, or any ranges therebetween.

In a typical CVD process a substrate (e.g., glass fiber or battery separator made of glass fibers) is placed in a reaction chamber where it is exposed to one or more volatile precursors which react and/or decompose on the surface of the substrate to produce the desired deposit (e.g., a coating of silicon oxide). By-products produced by the process are removed by inert gas flow through the reaction chamber.

CVD processes operate at a variety of pressures ranging from 10,000 torr to ultrahigh vacuum (e.g., 10⁻⁸ ton). In some embodiments, the pressure ranges from 10,000 ton to atmospheric pressure (e.g., from about 10,000 ton to about 5,000 ton, from about 10,000 ton to about 1,000 ton, from about 5,000 ton to about atmospheric). In some embodiments, the pressure ranges from about atmospheric pressure to about 10⁻⁸ ton, from about atmospheric pressure to about 10⁻² ton, from about atmospheric pressure to about 10⁻⁴ ton, from about 10⁻² ton to about 10⁻⁴ ton, from about 10⁻² ton to about 10⁻⁶ ton, from about 10⁻⁴ ton to about 10⁻⁶ ton, from about 10⁻⁴ ton to about 10⁻⁸ ton, from about 10⁻⁶ ton to about 10⁻⁸ ton or any ranges therebetween.

CVD processes may also involve a variety of vapors of precursors, including aerosol assisted vapors in which the precursor is transported by means of a liquid-gas aerosol. In other instances, direct liquid injection is used in which the precursors in liquid form are injected to a vaporization chamber, where they vaporize and are then transported to the substrate for reaction/deposition.

CVD processes may involve combustion to generate reactive precursors to the coating. Combustion CVD methods can enhance reaction and deposition rates. In combustion CVD methods a precursor compound usually a metal organic (e.g., tetraethyl silica) or a metal salt is added to a burning fuel (e.g., ethanol). The flame is placed near the substrate to be coated. Generally, either the flame or substrate is moved relative to the other to ensure coverage. The energy from combustion in the flame converts the precursor to reactive intermediates which react with the substrate forming an adhered deposit. Process parameters can be manipulated to vary the structure, thickness and other physical properties of the coating, as well as the rate of deposition. Exemplary process parameters include but are not limited to flame temperature, distance between flame and substrate, rate of movement between the flame and substrate, number of passes.

In combustion CVD the temperature of the substrate can range from between about 100° C. to about 500° C. (e.g., be about 100° C., about 200° C., about 250° C., about 300° C., about 350° C., about 400° C., about 450° C. or about 500° C.). In some embodiments, the temperature of the substrate can range from between about 100° C. to about 200° C., from between about 100° C. to about 250° C., from between about 200° C. to about 300° C., from between about 200° C. to about 350° C., from between about 250° C. to about 350° C., from between about 250° C. to about 400° C., from between about 300° C. to about 400° C., from between about 300° C. to about 450° C., from between about 400° C. to about 500° C. or any ranges therebetween. The flame temperature in combustion CVD can range from between about 300° C. to about 2800° C. In some embodiments, the flame temperature can range from between about 300° C. to about 600° C., from between about 300° C. to about 900° C., from between about 600° C. to about 1200° C., from between about 600° C. to about 1500° C., from between about 900° C. to about 1500° C., from between about 900° C. to about 1800° C., from between about 1200° C. to about 1800° C., from between about 1200° C. to about 2100° C., from between about 1500° C. to about 2100° C., from between about 1500° C. to about 2400° C., from between about 1800° C. to about 2400° C., from between about 1800° C. to about 2800° C. or any ranges therebetween.

CVD processes may also involve the use of a plasma. Similar to combustion CVD, described above, the plasma can enhance chemical reaction rates of the precursors and may reduce the overall temperatures required for the depositions. A plasma is used in a similar way to the flame in combustion CVD to produce intermediates from precursor chemicals. The coating is deposited in much the same manner as combustion CVD, in that the intermediate compounds react with the substrate to produce the coating. Advantageously, some plasma assisted CVD methods can be performed at room temperature (e.g., remote plasma-enhanced CVD).

Other methods of CVD that can be employed to coat a substrate (e.g., glass fiber or battery separator made from glass fibers) include, but are not limited to, atom layer CVD, hot wire CVD, metalorganic CVD, hybrid physical-chemical CVD, rapid thermal CVD and vapor phase epitaxy.

In some embodiments, metal organic CVD (“MOCVD”) is used to create the coating on the glass fibers or separator. Generally, MOCVD is a thin film generation method that uses the reaction of organic compounds (i.e., metalorganics and/or metal hydrides) which react on the surface of the substrate to be coated. MOCVD techniques are typically performed under vacuum with an inert atmosphere (e.g., about 0.2 torr) and at elevated temperature (e.g., about 400° C.). The temperature varies depending on the metalorganic source and the desired product.

The metalorganic compound is present in a vessel, called a bubbler. In some embodiments, an inert carrier gas (e.g., argon) is bubbled through the metalorganic compound, though a reactive gas (e.g., oxygen or hydrogen) can also be used as the carrier gas. The metalorganic compound is usually a liquid. The metalorganic is carried by the gas to the reaction chamber. Oxygen and/or hydrogen are mixed with the metalorganic gas in the reaction chamber. The metalorganic and the added gas react at the substrate's surface to form a thin layer of the metal hydride or metal oxide (e.g., silicon oxide).

The MOCVD process can, in some embodiments, lead to the production of metal oxide nanowires, as opposed to a continuous thin layer. In some embodiments, the nanowires can have a diameter ranging from about 30 nm to about 90 nm, e.g., about 30 nm to about 70 nm, about 30 nm to about 50 nm, about 50 nm to about 90 nm, about 50 nm to about 70 nm. In some embodiments, the length of the nanowires can be as much as several microns. Typically, the surface to be coated with nanowires is first coated with a thin layer of sputtered gold.

The precursor compounds for various CVD processes are typically metalorganic compounds (e.g., tetramethyl silane, tetraethyl silane). In some embodiments, the metalorganic compound is a methylated metal. In some embodiments, the metal organic compound is a trimethyl compound, e.g., trimethyl silane. In some embodiments, the metalorganic is a triisopropyl compound. In some embodiments, the metal organic compound is an ethylated metal (e.g., tetraethyl silane).

### Silica Coatings by Sputter Deposition

In some embodiments, sputter deposition may be used to create the silica (e.g., amorphous silica) coatings on a glass fiber or battery separator made from glass fibers (i.e., the substrate). Sputter deposition, also well known, involves the use of a target containing the material to be deposited on the substrate. Ions are ejected from the target (e.g., by bombardment or excitation) and these ions are then deposited on the substrate to form the coating. The ions may diffuse to the substrate after ejection or may be a projectile (i.e., travel in a straight line) and impact the substrate. Variations in temperature, pressure and materials used in the sputter deposition process modify the method of transport of ions within the reaction chamber. For example most efficient sputtering involves a sputtering gas with an atomic weight similar to that of the ejected ions.

In some embodiments, an inert gas is used in the sputtering process. In some embodiments, a reactive gas is used. When a reactive gas is used the ejected ions may react with the gas, either on the target surface (i.e., at ejection), in flight, or at the surface of the substrate. The composition of the resulting coating on the substrate can be controlled by varying the pressures of the inert and reactive gases.

Known sputter deposition processes applicable to the present invention include, but are not limited to, ion-beam sputtering, reactive sputtering, ion-assisted deposition, high target utilization sputtering, high power impulse magnetron sputtering and gas flow sputtering.

### Silica Coatings by Thermal Spraying

Thermal spraying techniques can also be used to produce coatings on a glass fiber or battery separator made from glass fibers (i.e., substrate). As compared to CVD techniques described above, thermal spraying techniques can provide thicker coatings over larger areas in a shorter amount of time. Typically, coating materials are fed to a spraying device in powder or wire form, heated to a molten or semi-molten state and accelerated toward the substrate. The spray is composed of many micrometer sized particles and the resulting coating is formed by accumulation of these particles. Although the spraying device may require heat, either from combustion or an electrical source, the substrate does not experience a substantial temperature increase.

In some embodiments, the spraying methods include, but are not limited to, plasma spraying, flame spraying, detonation spraying, wire arc spraying, high velocity oxy-fuel coating spraying, warm spraying and cold spraying.

In some embodiments, plasma spraying techniques are used to coat the substrate. In plasma spraying, the coating material is provided as a wire, powder, liquid or suspension. The plasma source is typically a plasma torch, which uses an electric arc to create a plasma from gas forced through a nozzle. The plasma forms as the gas exits the nozzle.

The feed is introduced into the plasma. The temperature of the jet can be as high as 10,000 K, which causes the material to melt, form droplets and propels the material to the substrate. Upon impact with the substrate, the coating materials flatten and cool, forming a deposited coating. The processes can be varied and controlled by changing the plasma temperature, coating material, distance between the substrate and the plasma torch, flow rates and cooling rates.

Plasma spraying includes several variations which are applicable to coating a substrate. These can be based on classification of the method of plasma jet generation (e.g., direct current, induction), the plasma forming medium (e.g., gas stabilized plasma, water stabilized plasma, or hybrid), and the spraying equipment (e.g., air plasma spraying, control atmosphere plasma spraying, high pressure plasma spraying and underwater plasma spraying). Plasma spraying may also include vacuum plasma spraying.

In flame spraying or spray pyrolysis techniques, the heat from the plasma is replaced by the combustion of fuel, typically, oxygen and a gas fuel (e.g., acetylene, propane). The heat from combustion melts the feed material, and the jet from combustion, or a jet from other compressed gases forms droplets and propels the melted coating material to the substrate. The feed material can be either a powder or a wire fed directly to the flame. If the feed material is a powder, it may be carried to the combustion nozzle by compressed air or an inert gas, though in some embodiments the powder is transported to the combustion nozzle by the venture effect of the combustion gas fuel and/or oxygen. In wire feed processes the wire material is fed through the center of a combustion nozzle. The combustion heats the wire and the combustion gases accelerate the melted wire particles to the substrate. This process may be aided by compressed air being fed to or around the nozzle, which aides in atomizing the melted wire particles.

Flame spraying processes can be varied and controlled by changing the combustion temperature, gas and feed flow rates and distance between the combustion nozzle and the substrate. Changes in process variables can result in changes in the coating quality, coating rate and bonding strength.

### Glass Fibers—Generally

Dimensions

In some embodiments, the glass fibers (such as microglass fibers and/or chopped glass fibers) contain (e.g., are formed entirely of) one or more glass materials. Various types of glass fibers can be used, such as glass fibers that are relatively inert to lead acid battery storage and use conditions.

The fibers can have various diameters. In addition to average diameters described elsewhere, in some embodiments, the fibers may have an average diameter of less than about 30 microns, e.g., from about 0.1 microns to about 30 microns. In some embodiments, the average diameter can be greater than or equal to about 0.1 microns, about 0.2 microns, about 0.4 microns, about 0.6 microns, about 0.8 microns, about 1 micrometer, about 2 microns, about 3 microns, about 5 microns, about 10 microns, about 15 microns, about 20 microns, or about 25 microns; and/or less than or equal to about 30 microns, about 25 microns, about 20 microns, about 15 microns, about 10 microns, about 5 microns, about 3 microns, about 2 microns, about 1 micrometer, about 0.8 microns, about 0.4 microns or about 0.2 microns. Average diameters of the glass fibers may have any suitable distribution. In some embodiments, the diameters of the fibers are substantially the same. In other embodiments, average diameter distribution for glass fibers may be log-normal. However, it can be appreciated that glass fibers may be provided in any other appropriate average diameter distribution (e.g., a Gaussian distribution, a bimodal distribution).

The fibers can also have various lengths. In some embodiments, the fibers may have an average length of less than about 75 millimeters, e.g., from about 0.0004 millimeter to about 75 millimeters. The average length can be greater than or equal to about 0.0004 millimeters, about 0.001 millimeters, about 0.01 millimeters, about 0.1 millimeters, about 0.50 millimeters, about 1 millimeter, about 5 millimeters, about 10 millimeters, about 15 millimeters, about 20 millimeters, about 25 millimeters, about 30 millimeters, about 40 millimeters, about 50 millimeters, about 60 millimeters, or about 70 millimeters; and/or less than or equal to about 75 millimeters, about 60 millimeters, about 50 millimeters, about 40 millimeters, about 30 millimeters, about 25 millimeters, about 20 millimeters, about 15 millimeters, about 10 millimeters, about 5 millimeters, about 1 millimeter, about 0.50 millimeters, about 0.1 millimeters, about 0.01 millimeters, about 0.001 millimeters, or about 0.0005 millimeters. The average length of a sample of fibers is determined by optical measure (e.g., microscopy, visually, scanning electron microscopy).

The dimensions of the fibers can also be expressed as an average aspect ratio. The average aspect ratio of a sample of fibers refers to the ratio of the average length of the sample of fibers to the average diameter (or width for fibers with non-circular cross sections) of the sample of fibers. In certain embodiments, the fibers have an average aspect ratio of less than about 10,000, for example, from about 5 to 10,000. The average aspect ratio can be greater than or equal to about 5, about 50, about 100, about 500, about 1,000, about 1,500, about 2,000, about 2,500, about 3,000, about 3,500, about 4,000, about 4,500, about 5,000, about 7,500, or about 9,000; and/or less than or equal to about 10,000, about 7,500, about 5,000, about 4,500, about 4,000, about 3,500, about 3,000, about 2,500, about 2,000, about 1,500, about 1,000, about 500, about 100, about 50 or about 10.

Examples of glass fibers that are suitable for various embodiments of the present invention include chopped strand glass fibers and microglass fibers. Chopped strand glass fibers and microglass fibers are known to those skilled in the art. One skilled in the art is able to determine whether a glass fiber is chopped strand or microglass by observation (e.g., optical microscopy, electron microscopy). Chopped strand glass may also have chemical differences from microglass fibers. In some cases, though not required, chopped strand glass fibers may contain a greater content of calcium or sodium than microglass fibers. For example, chopped strand glass fibers may be close to alkali free with high calcium oxide and alumina content. Microglass fibers may contain 10-15 percent alkali (e.g., sodium, magnesium oxides) and have relatively lower melting and processing temperatures. The terms refer to the technique(s) used to manufacture the glass fibers.

Such techniques impart the glass fibers with certain characteristics. In general, chopped strand glass fibers are drawn from bushing tips and cut into fibers. Microglass fibers are drawn from bushing tips and further subjected to flame blowing or rotary spinning processes. In some cases, fine microglass fibers may be made using a re-melting process. In this respect, microglass fibers may be fine or coarse. Chopped strand glass fibers are produced in a more controlled manner than microglass fibers, and as a result, chopped strand glass fibers will generally have less variation in fiber diameter and length than microglass fibers.

Compositions

In some embodiments, the disclosed glass fibers may include one or more of the following components in the following quantities: 50-75 weight percent SiO₂; 1-5 weight percent Al₂O₃; 0-30 weight percent Bi₂O₃; 3-7 weight percent CaO; 1-5 weight percent MgO; 4-9 weight percent B₂O₃; 0-3 weight percent each of ZrO₂ and K₂O; 9-20 weight percent of Na₂O; 0-2 weight percent NiO; 0-5 weight percent of each of ZnO and BaO; and 0-1 weight percent of each of Ag₂O, Li₂O and F₂O.

In some embodiments, the disclosed glass fibers may comprise one or more of the following components in the following quantities: 56-69 weight percent SiO₂; 2-4 weight percent Al₂O₃; 0.5-30 (e.g., 1-15) weight percent Bi₂O₃; 3-6 weight percent CaO; 2-4 weight percent MgO; 4-7 weight percent B₂O₃; 0.1-1.5 weight percent each of K₂O; 11.5-18 weight percent of Na₂O; 0-1 weight percent NiO; 0-3 weight percent of each of ZnO and ZrO₂; 0-0.1 weight percent of Ag₂O; 0-0.3 weight percent of Li₂O; 0-0.8 weight percent of F₂O; and 0-2 weight percent of BaO.

In some embodiments, the disclosed glass fibers may comprise between about 0.5 weight percent and about 30 weight percent bismuth oxide (e.g., about 0.5 to about 15 weight percent or about 0.5 to about 7 weight percent bismuth oxide). In some embodiments, the disclosed glass fibers may comprise less than about 0.5 weight percent bismuth oxide (e.g., about 0.1 to about 0.5 weight percent or about 0.2 to about 0.5 weight percent bismuth oxide).

One of ordinary skill in the art will recognize that the bulk concentrations, or ingredient list, represents the bulk composition of the glass fiber composition. Further, the XPS data expressing relative atomic percentages at the surface of the fibers is not equivalent to the bulk concentrations of components of the glass fibers expressed in weight percent.

### Separators—Generally

In some embodiments, the glass fibers described above can be formed into a separator. Generally, the separators are non-woven mats or bundles comprised of at least glass fibers disposed between the positive and negative plates in the battery. In some embodiments, the separator has a combination of chopped strand glass fibers and microglass fibers. In some embodiments, the separator may contain between about 0 weight percent to about 100 weight percent chopped strand glass fibers. In some embodiments, the separator may contain between about 5 weight percent to about 15 weight percent chopped strand glass fibers. In some embodiments, the separator may contain between about 0 weight percent to about 100 weight percent microglass fibers. In some embodiments, the separator may contain between about 85 weight percent to about 95 weight percent microglass fibers. In some embodiments, the separator may contain between about 85 weight percent to about 100 weight percent microglass fibers. The separator can be made using a papermaking type process (e.g., wet-laid, dry-laid, etc.). As a specific example, the separator can be prepared by a wet laid process, wherein, the separator may be formed by depositing a fiber slurry on a surface (such as a forming wire) to form a layer of intermingled fibers. The mixture (e.g., a slurry or a dispersion) containing the fibers in a solvent (e.g., an aqueous solvent such as water) can be applied onto a wire conveyor in a papermaking machine (e.g., an inclined former, a Fourdrinier, gap former, twin wire, multiply former, a Fourdrinier-cylinder machine, or a rotoformer) to form a layer supported by the wire conveyor. Additional types of fibers can be added to the slurry, as well as common additives. A vacuum is applied to the layer of fibers during the above process to remove the solvents from the fibers. The separator is then passed through the drying section, typically a series of steam heated rollers to evaporate additional solvent. Any number of intermediate processes (e.g., pressing, calendering, etc.) and addition of additives may be utilized throughout the separator formation process. Additives can also be added either to the slurry or to the separator as it is being formed, including but not limited to, salts, fillers including silica, binders, and latex. The additives may comprise between about 0 to about 30 percent by weight of the separator. During the separator forming process, various pH values may be utilized for the slurries. Depending on the glass composition the pH value may range from about 2 to about 4. Furthermore, the drying temperature may vary, also depending on the fiber composition. In various embodiments, the drying temperature may range from about 100° C. to about 700° C. The separator may comprise more than one layer, each layer comprising different types of fibers with different physical and chemical characteristics.

Alternatively or additionally, the separator can include one or more other compositions. For example, the separator can include non-glass fibers, natural fibers (e.g., cellulose fibers), synthetic fibers (e.g., polymeric, regenerated cellulose), ceramic or any combination thereof. Alternatively or additionally, the separator can include thermoplastic binder fibers. Exemplary thermoplastic fibers include, but are not limited to, bi-component, polymer-containing fibers, such as sheath-core fibers, side-by-side fibers, “islands-in-the-sea” and/or “segmented-pie” fibers. Examples of types of polymeric fibers include substituted polymers, unsubstituted polymers, saturated polymers, unsaturated polymers (e.g., aromatic polymers), organic polymers, inorganic polymers, straight chained polymers, branched polymers, homopolymers, copolymers, and combinations thereof. Examples of polymer fibers include polyalkylenes (e.g., polyethylene, polypropylene, polybutylene), polyesters (e.g., polyethylene terephthalate), polyamides (e.g., nylons, aramids), halogenated polymers (e.g., polytetrafluoroethylenes), and combinations thereof.

In some embodiments, the specific surface area of a separator can range from about 0.5 m²/g to about 18 m²/g, for example, from about 1.3 m²/g to about 1.7 m²/g. The specific surface area can be greater than or equal to about 0.5 m²/g, about 1 m²/g, about 2 m²/g, about 3 m²/g, about 4 m²/g, about 5 m²/g, about 6 m²/g, about 7 m²/g, about 8 m²/g, about 9 m²/g, about 10 m²/g, about 12 m²/g, about 15 m²/g or about 18 m²/g, and/or less than or equal to about 18 m²/g, about 15 m²/g, about 12 m²/g, about 11 m²/g, about 10 m²/g, about 9 m²/g, about 8 m²/g, about 7 m²/g, about 6 m²/g, about 5 m²/g, about 4 m²/g, about 3 m²/g, about 2 m²/g, about 1 m²/g, or about 0.6 m²/g. The BET surface area is measured according to method number 8 of Battery Council International Standard BCIS-03A (2009 revision), “BCI Recommended Test Methods VRLA-AGM Battery Separators”, method number 8 being “Surface Area.” Following this technique, the BET surface area is measured via adsorption analysis using a BET surface analyzer (e.g., Micromeritics Gemini II 2370 Surface Area Analyzer) with nitrogen gas; the sample amount is between 0.5 and 0.6 grams in a ¾″ tube; and, the sample is allowed to degas at 75° C. for a minimum of 3 hours.

The basis weight, or grammage, of the separator can range from about 15 gsm to about 500 gsm. In some embodiments, the basis weight ranges from between about 20 gsm to about 100 gsm. In some embodiments, the basis weight ranges from between about 100 gsm to about 200 gsm. In some embodiments, the basis weight ranges from about 200 gsm to about 300 gsm. In some embodiments, the basis weight of pasting paper, described below, including the surface modified fibers, ranges from between about 15 gsm to about 100 gsm. The basis weight or grammage is measured according to method number 3 “Grammage” of Battery Council International Standard BCIS-03A (2009 Rev.) “BCI Recommended test Methods VRLA-AGM Battery Separators.”

In some embodiments, the thickness of the separator can vary. The thickness of the separator in a battery can range from greater than zero to about 5 millimeters. The thickness of the separator can be greater than or equal to about 0.1 mm, about 0.5 mm, about 1.0 mm, about 1.5 mm, about 2.0 mm, about 2.5 mm, about 3.0 mm, about 3.5 mm, about 4.0 mm, or about 4.5 mm; and/or less than or equal to about 5.0 mm, about 4.5 mm, about 4.0 mm, about 3.5 mm, about 3 mm, about 2.5 mm, about 2.0 mm, about 1.5 mm, about 1.0 mm, or about 0.5 mm. In some embodiments, the thickness of pasting paper, described below, including the surface modified fibers, ranges from between about 0.1 mm to about 0.9 mm. The thickness is measured according to method number 12 “Thickness” of Battery Council International Standard BCI5-03A (2009 Rev.) “BCI Recommended test Methods VRLA-AGM Battery Separators.” This method measure the thickness with a 1 square inch anvil load to a force of 10 kPa (1.5 psi).

The glass fibers disclosed may have application beyond the described battery separators. For example, the surface modified fibers may be used in other aspects of battery construction and/or other batter components (e.g., as components in pasting paper). Pasting paper is manufactured in a similar paper-making manner as described for the battery separators. Pasting paper, generally, may have a lower basis weight, and be thinner, as compared to the battery separators. The pasting paper is used in electrode plate construction, described below. Some electrode plates are constructed from an aqueous lead oxide paste applied to a grid. The pasting paper is used to retain the shape of the plate while the paste dries. The pasting paper may also be used to cover an electrode plate before installation in a battery, or in application of an active material to the plate. The glass fibers could also be added in loose form to the battery electrolyte (i.e., in addition to or instead of the separator and/or pasting paper).

### Batteries—Generally

The other components of a battery can be conventional components. Anode plates and cathode plates can be formed of conventional lead acid battery electrode materials. For example, in container formatted batteries, plates, can include grids that include a conductive material, which can include, but is not limited to, lead, lead alloys, graphite, carbon, carbon foam, titanium, ceramics (such as Ebonex®), laminates and composite materials. The grids are typically pasted with lead-based active materials. The pasted grids are typically converted to positive and negative battery plates by a process called “formation.” Formation involves passing an electric current through an assembly of alternating positive and negative plates with separators between adjacent plates while the assembly is in a suitable electrolyte. In some embodiments, battery is one-shot formed, wherein acid is added to the container only once. For dry charge plates, the plates are placed in acid baths and connected to an electric current.

As a specific example, anode plates contain lead as the active material, and cathode plates contain lead dioxide as the active material. Plates can also contain one or more reinforcing materials, such as chopped organic fibers (e.g., having an average length of 0.125 inch or more), metal sulfate(s) (e.g., nickel sulfate, copper sulfate), red lead (e.g., a Pb₃O₄-containing material), litharge, paraffin oil, and/or expander(s). In some embodiments, an expander contains barium sulfate, carbon black and lignin sulfonate as the primary components. The components of the expander(s) can be pre-mixed or not pre-mixed. Expanders are commercially available from, for example, Hammond Lead Products (Hammond, Ind.) and Atomized Products Group, Inc. (Garland, Tex.). An example of a commercially available expander is Texex® expander (Atomized Products Group, Inc.). In certain embodiments, the expander(s), metal sulfate(s) and/or paraffin are present in anode plates, but not cathode plates. In some embodiments, anode plates and/or cathode plates contain fibrous material described in U.S. Patent Application Publication No. 2006/0177730.

A battery can be assembled using any desired technique. For example, separators are wrapped around electrode plates (e.g., cathode plates, anode plates). Anode plates, cathode plates and separators are then assembled in a case using conventional lead acid battery assembly methods. In certain embodiments, separators are compressed after they are assembled in the case, i.e., the thickness of the separators are reduced after they are placed into the case. An electrolytic mixture (e.g., just sulfuric acid, or sulfuric acid and silica) is then disposed in the case.

In the case of gelled electrolyte batteries, silica can be added to the electrolyte mixture. The silica can be colloidal silica, fumed silica, precipitated silica, and/or never dried precipitated silica, for example. The silica concentration can be adjusted so that, after the sulfuric acid is absorbed by the separator, the silica can gel with the sulfuric acid external to the separator.

In some embodiments, fibrous material (e.g., fibers or fiber slurries described in U.S. Patent Application Publication No. 2006/0177730) is added into the case (e.g., in a head space between the top surfaces of plates and the case, between the interior wall of the case and the plates, in one or more anode plates, in one or more cathode plates, in one or more separators, and/or between the sides and bottom of the anode plates and cathode plates). The fibrous material can be added to the case prior to and/or after the addition of the electrolytic mixture into the case. Other methods of adding the fibrous material are described in U.S. Patent Application Publication No. 2006/0177730. The amount of electrolytic mixture that is disposed within the case is sufficient to properly wet separators and, if applicable, to wet (e.g., to saturate) the fibrous material in the case. A cover is then put in place, and terminals are added.

While a number of embodiments have been described, the invention is not limited to these embodiments.

In some embodiments, the separator can include one or more additives. Examples of additives include fillers (e.g., silica, diatomaceous earth, celite, zirconium, plastics). The additives can be used in the range of less than about 0.5 percent to about 70 weight percent. In some embodiments, which include additives, the separator comprises glass fibers and powdered silica or another powdered material that is inert to battery reactions and materials that are present in a battery. The separator is made, in accordance with the method of this invention, and additives may be added to the separator in the slurry or via an additional headbox.

The electrolytic mixture can include other compositions. For example, the electrolytic mixture can include liquids other than sulfuric acid, such as a hydroxide (e.g., potassium hydroxide). In some embodiments, the electrolytic mixture includes one or more additives, including but not limited a mixture of an iron chelate and a magnesium salt or chelate, organic polymers and lignin, ions of tin, selenium and bismuth and/or organic molecules, and phosphoric acid.

Additional embodiments are disclosed in the following examples, which are illustrative only and not intended as limiting.

### EXAMPLES

### Example 1

### Standard Fiber Comparison

### Overall Experimental Design

An experiment was devised to test the electro-chemical differences between standard glass fibers and the surface modified glass fibers of the present disclosure. A test cell was constructed and its performance with both standard and surface modified glass fibers was measured and compared. Specifically, the voltage at the negative electrode of the test cell was varied and the current through the cell was measured. A rapid change in the current as the voltage was increased was used as an indicator of hydrogen production at the negative electrode. Hydrogen production, in turn, indicates that oxygen is no longer being recombined at the negative electrode thus signaling the maximum ability of the cell to recombine oxygen. The higher the voltage at the negative electrode before hydrogen production, the better the performance of the cell.

Materials and Cell Construction

The test cell was constructed in a beaker, 6 cm deep and 8 cm in diameter. A 0.125″ diameter lead wire formed in to a 1″ long coil was used as the positive counter electrode, and to generate oxygen. A 0.25″ diameter lead wire with 0.250″ of exposed length was used as the negative working electrode. The negative electrode was controlled by a mercurous sulfate/mercury reference electrode. The negative electrode voltage was varied from 0.8 V to 1.75 V, as compared to the reference electrode. 400 ml of sulfuric acid solution was used as the electrolyte solution. The electrolyte solution had a specific gravity of 1.26 g/cm³. Different glass fibers were added to the solution to evaluate their ability to aid oxygen transport. The electrolyte and fibers were stirred using a magnetic stir bar. This procedure is a variation of the Electrochemical Compatibility test issued by the Battery Council International (BCIS-03a Rev. February 02) and is based on AT&T Technology Systems Manufacturing Standard 17000 Section 1241. The experimental setup is different from the BCI method in that the oxygen generating counter electrode is in the same vessel as the working negative electrode.

Experimental/Operational Procedure

The electrodes were conditioned for 10 cycles, varying the negative electrode voltage from 0.8 V to 1.75 V versus a mercury/mercurous sulfate reference electrode to condition the electrodes and obtain a steady state of dissolved gases in the electrolyte. After ten cycles, an individual voltage scan was performed from 0.8 V to 1.75 V as compared to the reference electrode, and the current recorded as the voltage varied. This was the blank scan, or base line, to which the electrochemical response was compared after addition of fibers to the electrolyte.

Glass Fiber Addition

0.25 g of glass fibers were added, either the standard (control) glass fibers or the surface modified glass fibers, to the 400 ml of electrolyte to simulate a glass mat separator in a VRLA battery. A repeat scan was taken after fiber addition and compared to the blank sample to elucidate the effect of the glass fibers on the negative electrode response.

Results

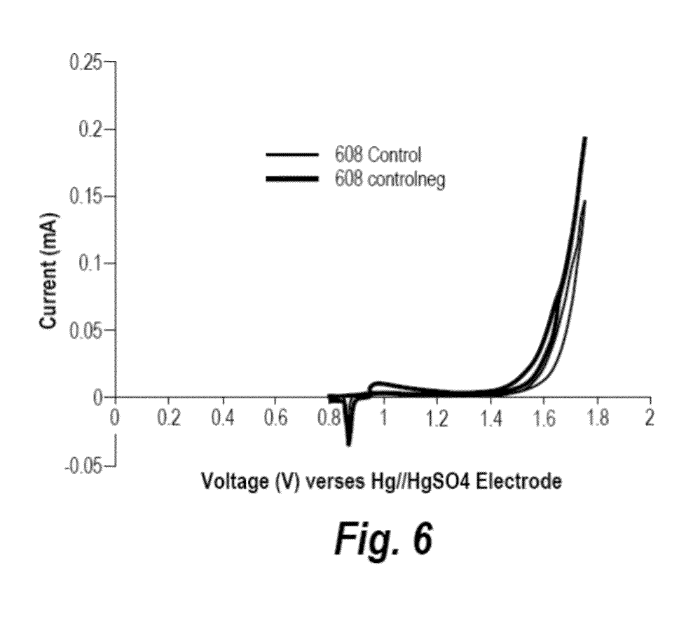

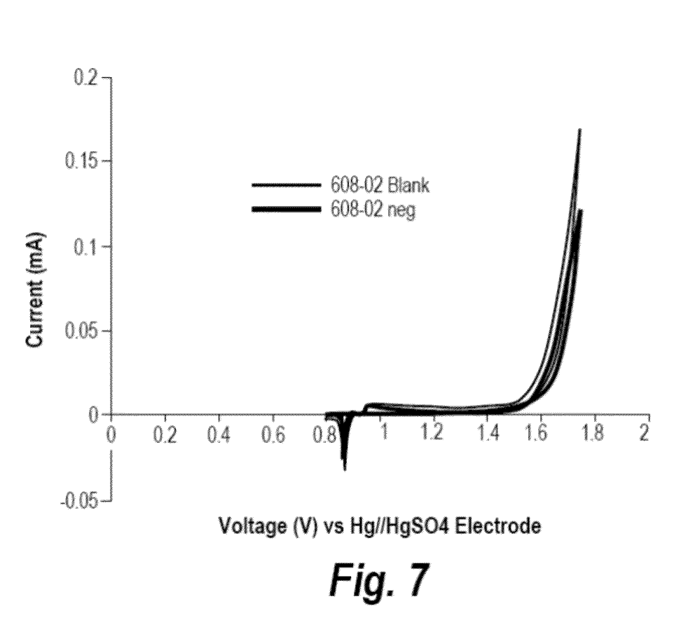

Evanite 608M fibers made by traditional fiberization method were analyzed for oxygen transport and compared to 608M fibers made by fiberization under oxygen enriched conditions, i.e., surface modified fibers. The results are shown in FIGS. 6 and 7. As can be seen from FIG. 6, the inclusion of the standard glass fibers shifted the generation of hydrogen (indicated by the rapid rise in current to the right of the figure) to the left, i.e., to a lower voltage. This is mostly due to impurities that were introduced into the electrolyte by the fibers. A hydrogen shift in the range of −20 to −60 mV was observed.

Voltage scan results for surface modified Evanite 608M fibers made under oxygen enriched conditions are shown in FIG. 7. Here it is noted that the hydrogen evolution is shifted to the right, i.e., to a higher voltage. The surface modified fibers shift the hydrogen evolution to a higher voltage, overcoming trace impurities that are also present in the oxygen enriched fibers, indicating enhanced oxygen recombination at the negative electrode.

### Example 2

### Coarse Fiber Comparison

The 608M fibers that were used in Example 1 have a relatively small diameter (about 0.8 micron average diameter). Coarser diameter fibers (Evanite 609M fibers, about 1.3 micron average diameter) made under oxygen enriched conditions were also evaluated and compared with another type of small diameter standard glass fiber (Johns Manville 206-253 fibers, about 0.76 micron average diameter). Again, the surface modified fibers were shown to delay hydrogen evolution, even above trace contamination levels contributed by the fibers, indicating more efficient oxygen transfer. The standard 206-253 fibers, like the 608M control fibers showed hydrogen evolution occurring at a lower voltage. All test results are summarized in Table 1.

TABLE 1

| | | Voltage | Voltage | H₂ |
|---|---|---|---|---|
| | Current | of Blank | of Test | Generation |
| Sample | (A) | Cell (V) | Cell (V) | Shift (mV) |
| 608M (unmodified) | 0.020 | 1.622 | 1.588 | −34.3 |
| 608M (unmodified) | 0.030 | 1.642 | 1.612 | −29.7 |
| 608M - oxygen (surface | 0.020 | 1.625 | 1.635 | 10.7 |
| modified fibers) | | | | |
| 608M - oxygen (surface | 0.030 | 1.644 | 1.665 | 20.8 |
| modified fibers) | | | | |
| 206-253 (unmodified) | 0.020 | 1.594 | 1.539 | −55.1 |
| 206-253 (unmodified) | 0.030 | 1.619 | 1.568 | −51.1 |
| 609M - oxygen (surface | 0.020 | 1.642 | 1.649 | 6.7 |
| modified fibers) | | | | |
| 609M - oxygen (surface | 0.030 | 1.671 | 1.678 | 6.7 |
| modified fibers) | | | | |

### Example 3

### XPS Analysis of Surface Modified Fibers Produced in an Oxygen Rich Atmosphere

XPS data presented in these Examples were generated on a ThermoScientific ESCALAB 250 device (ThermoScientific, Waltham, Mass.). The spot size was 400 μm and monochromatized Al X-ray was used as the irradiation source. The pass energy was 150 eV for survey scans and 50 eV for multiplex (composition) scans. Binding energy scales were adjusted in spectra plots to hydrocarbon in C1s at 284.8 eV.

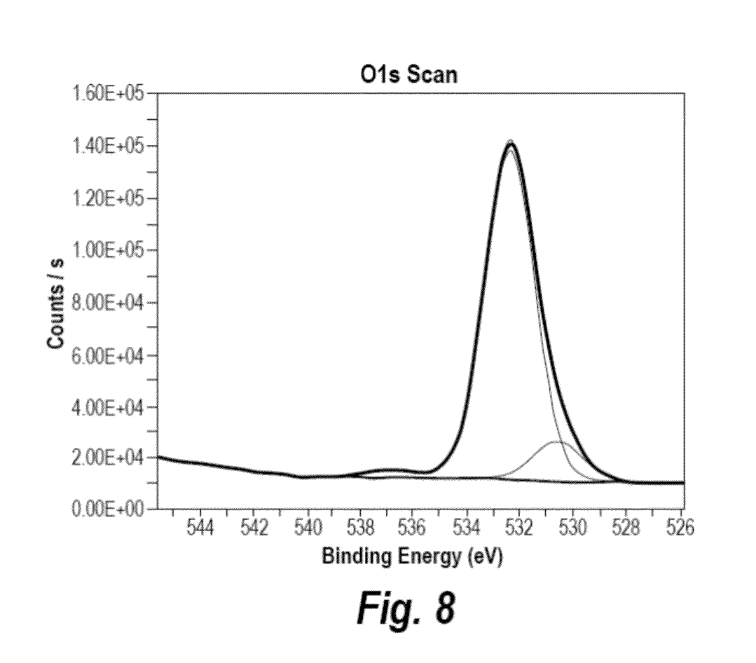

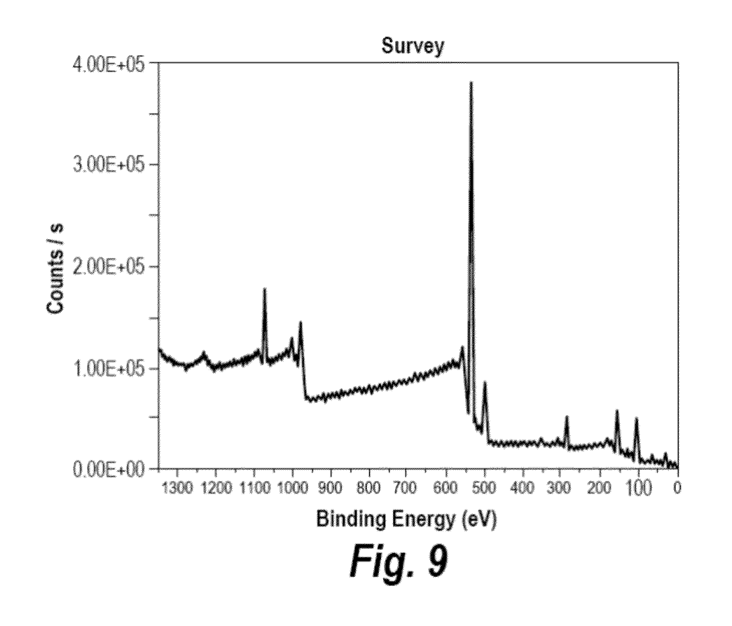

The atomic percentages that were obtained by XPS analysis are shown in Table 2. The 608M and 609M oxygenated glass fiber samples had higher percentages of oxygen at about 532.7 eV when compared to the 608M and 609M control glass fibers. The O1s peak fit and survey scan for the 609M oxygenated glass fiber sample are shown in FIGS. 8 and 9, respectively.

TABLE 2

| | | | | | | | | | | Si—O |
|---|---|---|---|---|---|---|---|---|---|---|
| Sample | C | Ca | K | Mg | N | Na | ~531 eV | ~532.7 eV | ~537 eV | (2p) |
| 608M Control | 17.7 | 1.2 | 0.2 | 0.6 | 0.2 | 6.5 | 10.1 | 38.0 | 0.9 | 24.6 |
| 608M Oxygen | 13.9 | 1.3 | 0.4 | 0.8 | 0.3 | 7.1 | 9.3 | 41.5 | 1.0 | 24.4 |
| 609M Control | 28 | 0.5 | — | — | 0.6 | 4.6 | 8.9 | 33.3 | 0.6 | 23.4 |
| 609M Oxygen | 25.6 | 0.7 | 0.1 | 0.3 | 0.3 | 4.4 | 5.8 | 39.5 | 0.5 | 22.8 |
| JM 206-253 | 16.6 | 0.5 | — | — | 0.6 | 6.5 | 5.5 | 44.3 | 1.1 | 24.9 |
| Lauscha C08 | 17.7 | 0.3 | — | — | 0.4 | 5.5 | 5.3 | 44.2 | 1.0 | 25.6 |

As discussed elsewhere, the oxygen peak at about 532.7 eV can include contributions from oxygen atoms that are bonded to silicon and oxygen atoms that are bonded to carbon. The data above was generated without performing a peak-fit analysis of these overlapping peaks. However, based on the hydrocarbon percentages that are provided, one of ordinary skill in the art, will recognize that the contribution of oxygen bonded to carbon to the 532.7 eV peak will be on the order of about 2-4 percent. Revising Table 2 to account for this overlap at about 532.7 eV yields the values in Table 3 below.

TABLE 3

| | ~532.7 eV | ~532.7 eV | 532.7 eV |
|---|---|---|---|
| Sample | (total) | SiOx (sp3) | (organic) |
| 608M Control | 38.0 | 34.0-36.0 | 2-4 |
| 608M Oxygen | 41.5 | 37.5-39.5 | 2-4 |
| 609M Control | 33.3 | 29.3-31.3 | 2-4 |
| 609M Oxygen | 39.5 | 35.5-37.5 | 2-4 |
| JM 206-253 | 44.3 | 40.3-42.3 | 2-4 |
| Lauscha C08 | 44.2 | 40.2-42.2 | 2-4 |

As discussed herein, in certain embodiments it may be useful to normalize the atomic percentages based on the average surface area of the underlying glass fiber. The dimensions of the glass fibers that were tested in this Example are presented in Table 4.

TABLE 4

| | Average Fiber | Average Fiber | Specific Surface |
|---|---|---|---|
| Sample | Diameter (μm) | Length (μm) | Area (m²/g) |
| 608M | 0.8 | 268 | 2.2 |
| 609M | 1.4 | 484 | 1.76 |
| JM 206-253 | 0.76 | 268 | 2.35 |
| Lauscha C08 | 0.8 | 336 | 2.35 |

When normalizing to the surface area of the 609M fibers, the percentages at about 532.7 eV become:

TABLE 5

| | ~532.7 eV | ~532.7 eV |
|---|---|---|
| Sample | (total) | SiOx (sp3) |
| 608M Control | 30.4 | 27.2-28.8 |
| 608M Oxygen | 33.2 | 30.0-31.6 |
| 609M Control | 33.3 | 29.3-31.3 |
| 609M Oxygen | 39.5 | 35.5-37.5 |
| JM 206-253 | 33.2 | 30.2-31.7 |
| Lauscha C08 | 33.1 | 30.1-31.6 |

### Example 4

### XPS Analysis of Silica Coated Fibers

This examples describes the XPS analysis of glass fibers in separators that were coated with silica using a CCVD technique and tetraethyl orthosilicate (TEOS) as the precursor. Each separator was prepared using standard Evanite 408 glass fibers (about 0.8 micron average diameter). One of the separators was used without further modification as a control (denoted 408 control). The two other separators were coated with silica using a CCVD technique and used as duplicate test separators (denoted as AAA-52C and AAA-52D). XPS spectra of the 408 control, AAA-52C and AAA-52D separators were taken on a ThermoScientific ESCALAB 250 device (ThermoScientific, Waltham, Mass.). The spot size was 500 microns and monochromatized Al X-ray was used as the irradiation source. The pass energy was 150 eV for survey scans and 20 eV for multiplex (composition) scans. Binding energy scales were adjusted in spectra plots to hydrocarbon in C1s at 284.8 eV.

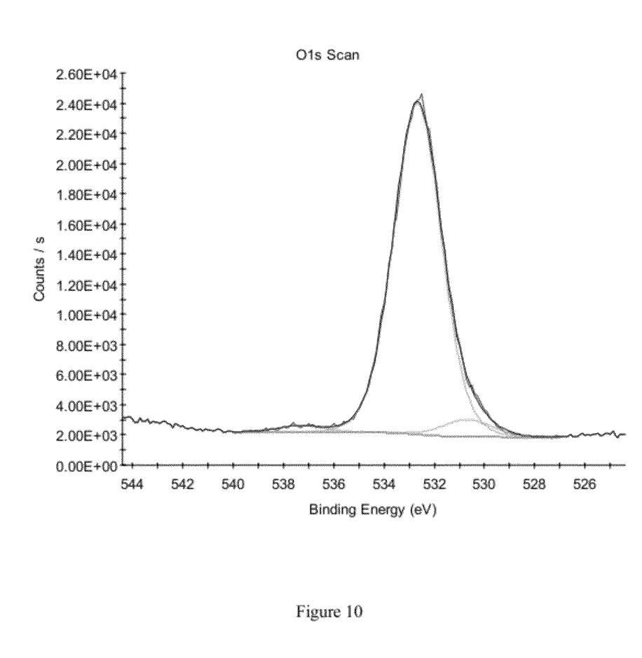

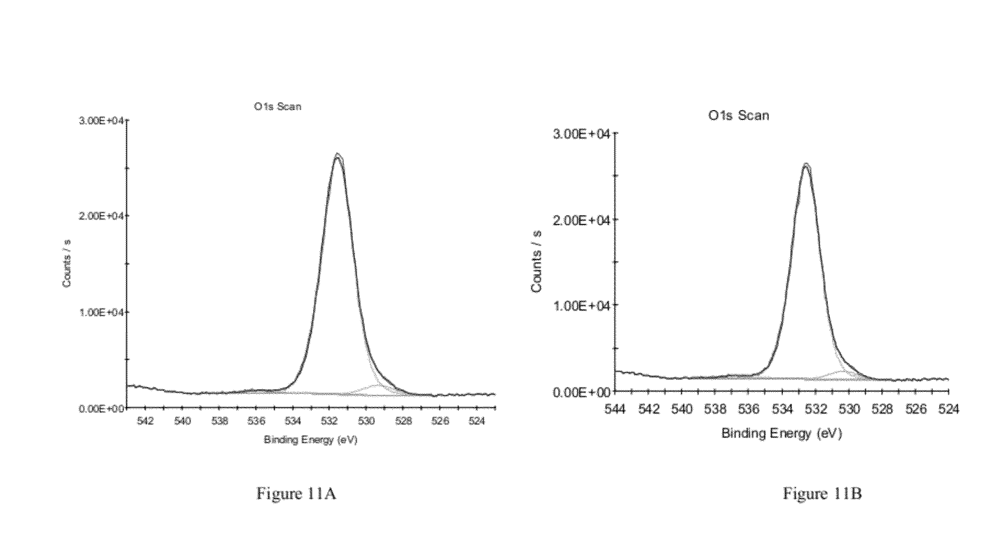

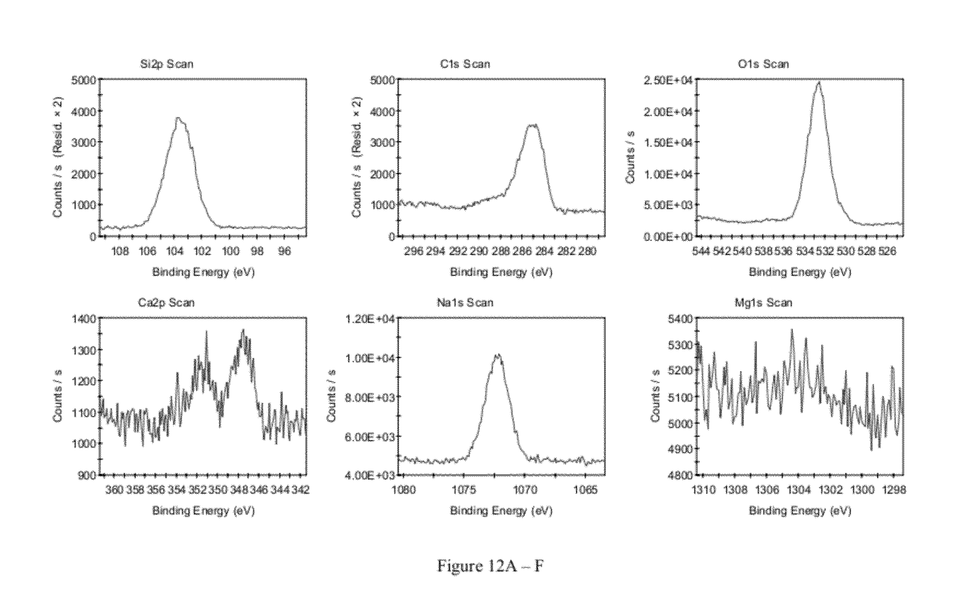

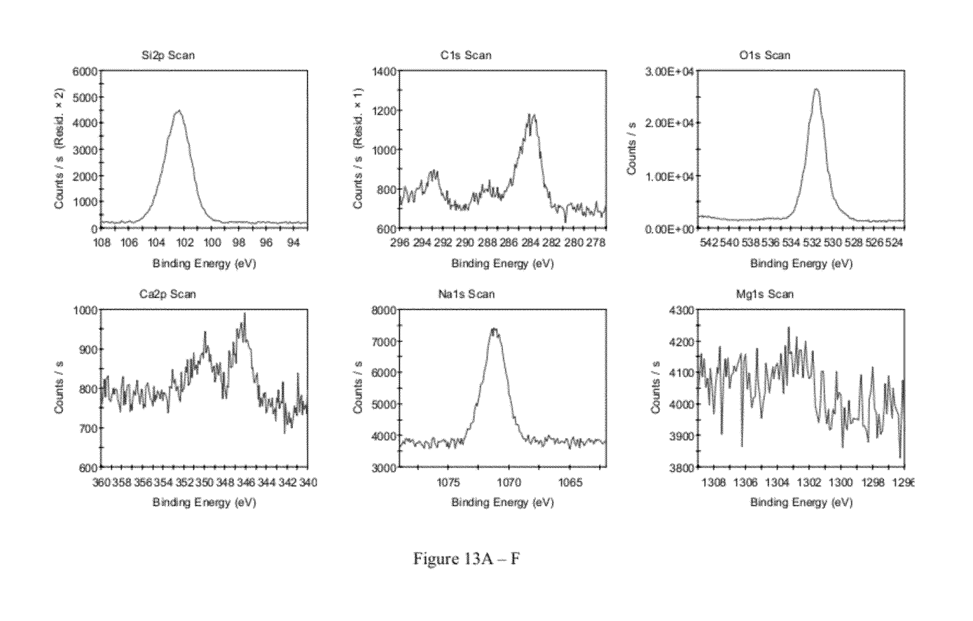

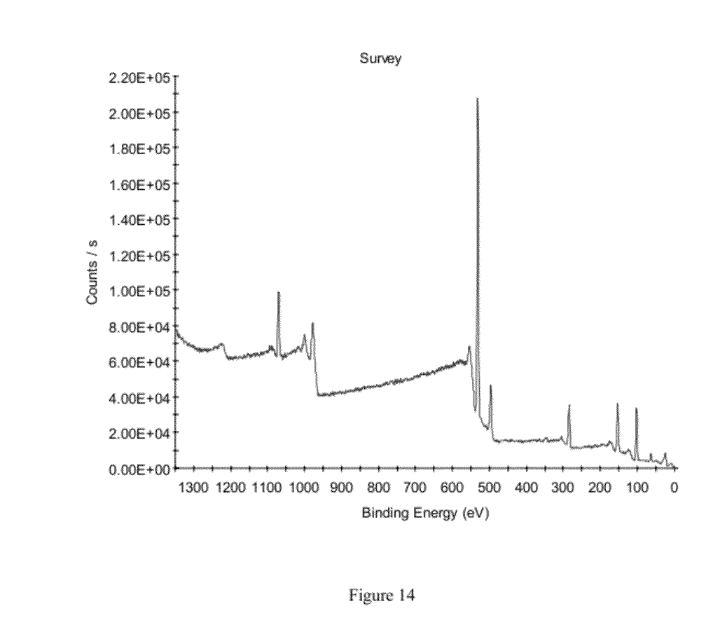

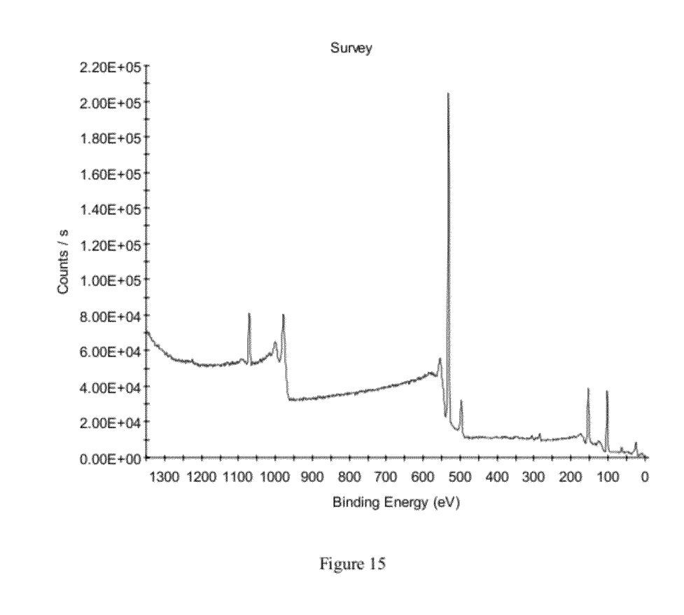

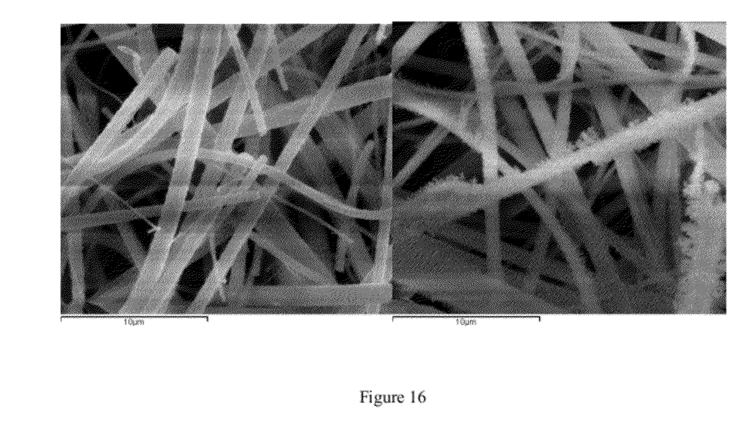

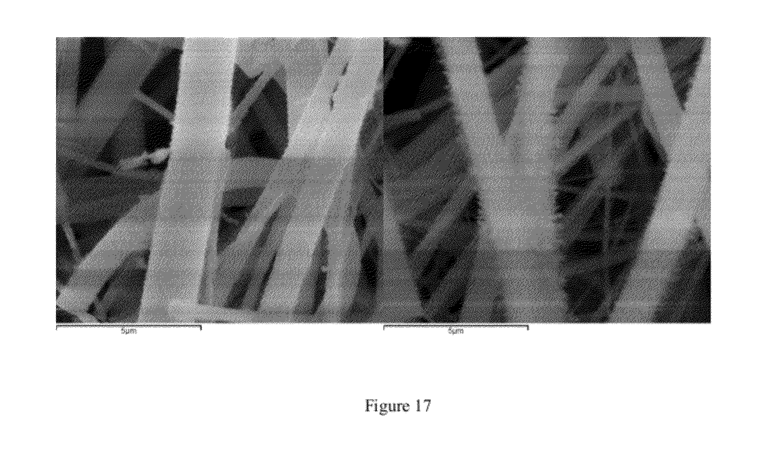

FIG. 10 shows an O1s peak fit profile from XPS analysis of the 408 control sample. FIGS. 11A and B show O1s peak fit profiles from XPS analysis of a surfaced modified sample (AAA-52D) (duplicate tests). FIGS. 12A-F show other peak fit profiles from XPS analysis of the 408 control sample. FIGS. 13A-F show other peak fit profiles from XPS analysis of a surface modified sample (AAA-52D). FIGS. 14 and 15 show XPS survey scans for the 408 control sample and surface modified sample AAA-52D, respectively. FIGS. 16 and 17 show electron micrographs taken of two samples (control on the left and surface modified on the right) at different levels of magnification.

The atomic percentages that were obtained by XPS analysis are shown in Table 6 below. The surface modified test samples (AAA-52C and AAA-52D) had higher percentages of oxygen at about 532.7 eV (total and SiOx) when compared to the 408 control. Of note, the highest percentage of oxygen at about 532.7 eV (SiOx) was also significantly higher than any of the values obtained with the glass fibers of Example 3.

TABLE 6

| | Hydro- | | | | | |
|---|---|---|---|---|---|---|
| Sample | carbon | C—O | C═O | O—C═O | Ca2p | Na1s |
| 408 | 12.0 | 5.7 | 0.9 | 1.4 | 0.7 | 5.0 |
| control | | | | | | |
| AAA-52C | 3.8 | 1.4 | 0.6 | 1.2 | 0.0 | 5.0 |
| AAA-52D | 2.8 | 1.0 | 0.2 | 0.6 | 0.2 | 3.7 |
| AAA-52D | 2.3 | 0.8 | 0.1 | 0.5 | 0.4 | 3.9 |
| rerun | | | | | | |

| | O1s (Binding Energy) | | | |
|---|---|---|---|---|
| | | ~532.6 eV | ~532.6 eV | |
| Sample | ~530.8 eV | SiOx (sp3) | (organic) | Si2p |
| 408 | 2.4 | 39.9 | 6.4 | 25.7 |
| control | | | | |
| AAA-52C | 2.0 | 53.2 | 2.0 | 30.7 |
| AAA-52D | 0.6 | 55.2 | 1.3 | 34.5 |
| AAA-52D | 2.3 | 54.8 | 1.0 | 33.9 |
| rerun | | | | |

As discussed herein, the peak at about 532.6 eV is characteristic of electrons from oxygen atoms that are bonded to silicon but also oxygen atoms that are bonded via a single bond to carbon. When this type of oxygen is also present in the surface being analyzed, its contribution to the 532.6 eV peak can be accounted for by analyzing the peaks that are produced by the corresponding carbon atoms. Indeed, as shown in Table 6, XPS analysis produces atomic percentages for carbon atoms in three different bonding arrangements, namely —C—O, —C═O and O—C═O (e.g., 5.7%, 0.9% and 1.4%, respectively in the control 408 sample). The atomic percentage of carbon (and therefore the corresponding percentage of oxygen) in a single bond with oxygen is therefore obtained by combining these values (i.e., 5.7%+0.5*1.4%=6.4% in the control 408 sample). The percentage obtained from carbons in an O—C═O arrangement is halved because the carbon is also bonded to a second oxygen via a double bond (and those oxygens produce the non-overlapping peak at about 530.8 eV).

Using this approach, the portion of oxygen at about 532.6 eV that is bound to silicon is indicated in the column titled “532.6 eV (SiOx)” (i.e., 39.9% for the 408 control) while the portion of oxygen at about 532.6 eV that is bound to carbon via a single bond is indicated in the column titled “532.6 eV (organic)” (i.e., 6.4% for the 408 control).

As discussed herein, in certain embodiments it may be useful to normalize the atomic percentages based on the average surface area of the underlying glass fiber. The dimensions of the glass fibers that were tested in this Example are presented in Table 8.

TABLE 7

| | Average Fiber | Average Fiber | Specific Surface |
|---|---|---|---|
| Sample | Diameter (μm) | Length (μm) | Area (m²/g) |
| 408M | 0.8 | 362 | 2.4 |

When normalizing to the surface area of the 609M fibers (used for normalization in Example 3), the percentages at about 532.6 eV become

TABLE 8

| | ~532.6 eV | ~532.6 eV |
|---|---|---|
| Sample | (total) | SiOx (sp3) |
| 408 control | 34.0 | 29.3 |
| AAA-52C | 40.5 | 39.0 |
| AAA-52D | 41.4 | 40.5 |
| AAA-52D | 40.9 | 40.2 |
| rerun | | |

1. A composition comprising:
glass fibers with a surface atomic percentage of oxygen bonded to silicon of at least about 45 percent;
wherein the fibers form at least a part of a battery separator.

2. The composition of claim 1, wherein the surface atomic percentage of oxygen bonded to silicon is measured by XPS at about 532.6 eV.

3. The composition of claim 1, wherein the glass fibers comprise between about 50 weight percent to about 75 weight percent silica, between about 1 weight percent to about 5 weight percent aluminum oxide, and less than about 25 weight percent sodium oxide.

4. The composition of claim 1, wherein the surface atomic percentage of oxygen bonded to silicon is measured to a depth of between about 100 and 150 Angstroms from the surface of the glass fibers.

5. The composition of claim 1, wherein the surface atomic percentage of oxygen bonded to silicon is at least about 48 percent.

6. The composition of claim 1, wherein the surface atomic percentage of oxygen bonded to silicon is at least about 51 percent.

7. The composition of claim 1, wherein the surface atomic percentage of oxygen bonded to silicon is at least about 54 percent.

8. The composition of claim 1, wherein the surface atomic percentage of oxygen bonded to silicon is at least about 57 percent.

9. The composition of claim 1, wherein the surface atomic percentage of oxygen bonded to silicon is at least about 60 percent.

10. The composition of claim 1, wherein the surface atomic percentage of oxygen bonded to silicon is at least about 63 percent.

11. The composition of claim 1, wherein the surface atomic percentage of oxygen bonded to silicon is at least about 65 percent.

12. The composition of claim 1, wherein the surface atomic percentage of oxygen bonded to silicon is in the range of about 45 to about 65 percent.

13. The composition of claim 1, wherein the surface atomic percentage of oxygen bonded to silicon is in the range of about 51 to about 65 percent.

14. The composition of claim 1, wherein the surface atomic percentage of oxygen bonded to silicon is in the range of about 54 to about 65 percent.

15. The composition of claim 1, wherein the surface atomic percentage of oxygen bonded to silicon is in the range of about 60 to about 65 percent.

16. The composition of claim 1, wherein the glass fibers comprise between about 60 weight percent and about 70 weight percent silica.

17. The composition of claim 1, wherein the glass fibers comprise between about 0.5 weight percent and about 30 weight percent bismuth oxide.

18. The composition of claim 1, wherein the glass fibers have an average diameter between about 0.1 and about 10 microns.

19. The composition of claim 1, wherein the glass fibers have an average diameter between about 0.5 and about 2 microns.

20. The composition of claim 1, wherein the glass fibers have an average diameter between about 0.5 and about 1 microns.

21. The composition of claim 1, wherein the glass fibers have an average diameter between about 1 and about 2 microns.

22. A battery, comprising:
a first electrode;
a second electrode, wherein at least one of the first and second electrodes comprises lead;
a separator between the first and second electrodes, wherein the separator comprises glass fibers with a surface atomic percentage of oxygen bonded to silicon of at least about 45 percent; and
an electrolytic solution.

23.-43. (canceled)

44. A lead acid battery, comprising:
a positive electrode;
a negative electrode;
an electrolytic solution; and
a means for shifting the voltage at which hydrogen is produced at the negative electrode by between about 10 mV and about 120 mV.

45. The lead acid battery of claim 44, wherein the battery comprises a means for shifting the voltage at which hydrogen is produced at the negative electrode by between about 30 mV and about 60 mV.
